(19) United States
(12) Patent Application Publication
(10) Pub. No.: US 2026/0004753 A1
(43) Pub. Date: Jan. 1, 2026

(54) TECHNIQUES FOR GROUPED GATE SCANNING IN FOVEATED DISPLAYS

(71) Applicant: Meta Platforms Technologies, LLC, Menlo Park, CA (US)

(72) Inventors: Qianqian Wang, Santa Clara, CA (US); Yongman Lee, Sunnyvale, CA (US); Misael Perez Martinez, Kirkland, WA (US)

(21) Appl. No.: 19/242,340

(22) Filed: Jun. 18, 2025

Related U.S. Application Data
(60) Provisional application No. 63/665,049, filed on Jun. 27, 2024.

(51) Int. Cl. G09G 3/36

(52) U.S. Cl. CPC G09G 3/3677; G09G 3/3614; G09G 2310/0205; G09G 2310/0286; G09G 2340/0407

(57) ABSTRACT

A display system is described comprising a plurality of gate driver units that are each coupled to a subset of a plurality of clock signal lines. Clock signals that are turned selectively on or off during a given time period may cause one or more of the gate driver units to produce one or more gate signals that each drives a row of display elements in a display. The clock signals may be controlled and may be coupled to the gate driver units in such a way that different numbers of rows of display elements may be driven by a gate signal based on the combined states of the clock signals. The display system may also comprise a plurality of demultiplexers configured to simultaneously relay display data to one or more columns of display elements of a display.

### CROSS REFERENCE TO RELATED APPLICATION

The present application claims the benefit under 35 U.S.C. § 119 (e) of U.S. Provisional Patent Application No. 63/665,049, filed Jun. 27, 2024, titled “Grouped Gate Scanning, Grouped Demultiplexing and Macro-Pixel Generation in LCDs,” the disclosure of which is hereby incorporated, in its entirety, by this reference.

### BACKGROUND

Foveated imaging is a display technique in which the image resolution can vary across a single image. For instance, a portion of an image corresponding to the center of the eye's retina (the fovea) may be rendered at a higher resolution than portions of the image far from the eye's retina. The regions of the image rendered with a lower resolution may not be noticeable due to the reduced contrast sensitivity of the eye at its periphery compared to its center.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 depicts an illustrative foveated display, according to some embodiments of the present disclosure.

FIG. 2 depicts addressing of display elements in a display, according to some embodiments of the present disclosure.

FIG. 3 depicts an approach to driving rows of display elements in a display, according to some embodiments of the present disclosure.

FIG. 4 depicts a portion of an illustrative display system configured to adjust a number of rows of display elements that are driven simultaneously, according to some embodiments of the present disclosure.

FIG. 5 depicts one illustrative implementation of the gate driver unit shown in FIG. 4, according to some embodiments of the present disclosure.

FIGS. 6-10 depict examples of operating a display system to drive rows of display elements, according to some embodiments of the present disclosure.

FIG. 11 depicts an example of driving columns of display elements, according to some embodiments of the present disclosure.

FIG. 12 depicts an approach to driving two columns of sub-pixels at once, according to some embodiments of the present disclosure.

FIG. 13 depicts an example of a 1:2 demultiplexer, according to some embodiments of the present disclosure.

FIG. 14 depicts an example of a 1:3 demultiplexer, according to some embodiments of the present disclosure.

FIG. 15 depicts an illustrative system that may be operated accordingly to the techniques described herein, according to some embodiments of the present disclosure.

FIG. 16 is an illustration of an example artificial-reality system according to some embodiments of this disclosure.

FIG. 17 is an illustration of an example artificial-reality system with a handheld device according to some embodiments of this disclosure.

FIG. 18A is an illustration of example user interactions within an artificial-reality system according to some embodiments of this disclosure.

FIG. 18B is an illustration of example user interactions within an artificial-reality system according to some embodiments of this disclosure.

FIG. 19A is an illustration of example user interactions within an artificial-reality system according to some embodiments of this disclosure.

FIG. 19B is an illustration of example user interactions within an artificial-reality system according to some embodiments of this disclosure.

FIG. 20 is an illustration of an example wrist-wearable device of an artificial-reality system according to some embodiments of this disclosure.

FIG. 21 is an illustration of an example wearable artificial-reality system according to some embodiments of this disclosure.

FIG. 22 is an illustration of an example augmented-reality system according to some embodiments of this disclosure.

FIG. 23A is an illustration of an example virtual-reality system according to some embodiments of this disclosure.

FIG. 23B is an illustration of another perspective of the virtual-reality systems shown in FIG. 23A.

FIG. 24 is a block diagram showing system components of example artificial- and virtual-reality systems.

FIG. 25 is an illustration of an example system that incorporates an eye-tracking subsystem capable of tracking a user's eye(s).

FIG. 26 is a more detailed illustration of various aspects of the eye-tracking subsystem illustrated in FIG. 25.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to techniques for driving a foveated display. As will be explained in greater detail below, embodiments of the present disclosure may include a controller that generates driving signals to address display elements in the foveated display, where display elements may be addressed singly or in groups to produce a foveated display image. Some displays may be driven by successively activating successive single display elements in a display. For instance, a selected row and a selected column may be driven together to address the single display element in both the selected row and selected column. This approach may, however, limit the production of very high resolution images due to high power usage and/or because the computing power available is too high to produce a desired frame rate. This may be especially true in portable devices, such as wearable devices (e.g., artificial reality devices), which are especially limited by power and/or compute capacity.

Embodiments of the present disclosure may provide a display system comprising a plurality of gate driver units that are each coupled to a subset of a plurality of clock signal lines. Clock signals that are turned selectively on or off during a given time period may cause one or more of the gate driver units to produce one or more gate signals that each drives a row of display elements in a display. The clock signals may be controlled and may be coupled to the gate driver units in such a way that different numbers of rows of display elements may be driven by a gate signal based on the combined states of the clock signals. For instance, the clock signals may be produced in one way to cause only a single gate driver unit to drive only a single row of display elements with a single gate signal, and produced in another way to cause one or more gate driver units to simultaneously drive multiple rows of display elements at the same time. The clock signals may be provided to the plurality of gate driver units in such a way to drive each row of display elements, where each row is either driven independently or is driven as part of a group of two, three, four, etc. rows of display elements. This process may allow multiple display elements to be simultaneously driven, thereby potentially reducing the amount of time needed to drive all the display elements in the display and increasing the frame rate. As described above, regions may be displayed at a lower resolution in some parts of a foveated display image, and this process may allow the production of such an image while potentially increasing frame rates.

Embodiments of the present disclosure may provide a display system comprising a plurality of demultiplexers configured to simultaneously provide display data to one or more columns of display elements of a display, where the plurality of demultiplexers includes demultiplexers configured to simultaneously provide display data to different number of columns at the same time. For instance, a first demultiplexer may be configured to provide display data to two different columns of display elements at the same time, whereas a second demultiplexer may be configured to provide display data to four different columns of display elements at the same time. The display data may for instance be an analog signal for controlling the color and/or brightness of a display element (e.g., an analog signal the controls the brightness of a sub-pixel of a certain color). The controller may select a desired one of the plurality of demultiplexers to receive a portion of the display data based on image data describing a foveated display image. The same display data may be provided to multiple columns of the display elements at the same time, thereby allowing multiple columns to be driven with the same image data. This process may allow multiple columns of display elements to be simultaneously driven to produce the same color, thereby potentially reducing the amount of data needed to drive all the display elements in the display.

Embodiments of the present disclosure may provide a display system in which both of the above approaches are realized at the same time, thereby allowing multiple rows and columns of display elements to be driven at the same time to cause a group of display elements to be operated in the same manner, potentially reducing data volume and increasing frame rates.

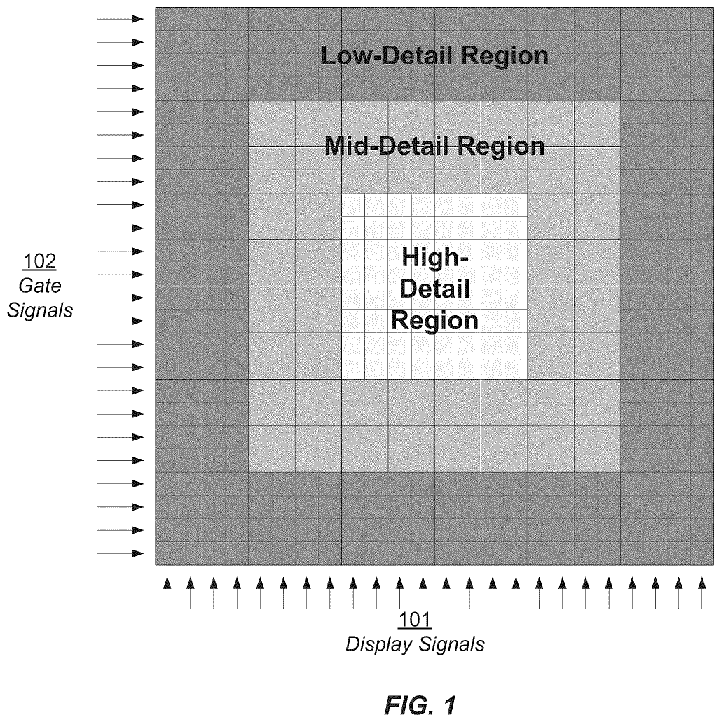

By way of further explanation, FIG. 1 depicts an illustrative foveated display comprising a grid of 576 (24×24) display elements (e.g., pixels and/or sub-pixels), according to some embodiments of the present disclosure. In the example of FIG. 1, an image is generated using a foveation pattern comprising a central high-detail region in which each of the 64 display elements in this region independently produce light of a desired color and/or brightness. In this foveation pattern, a mid-detail region surrounds the high-detail region, and a low-detail region surrounds the mid-detail region. In the mid-detail region, groups of 4 display elements (in a 2×2 block) are operated to produce the same output. In principal, any of the display elements in the high-detail region may appear different from one another when the display is operated to produce an image using the depicted foveation pattern, whereas in the mid-detail region each 2×2 block will appear uniform, effectively acting as a larger display element. Similarly, in the low-detail region in FIG. 1, 4×4 blocks of display elements are operated to produce the same output, effectively acting as a single display element that is even larger than those in the mid-detail region. Groups of multiple display elements operated to produce the same output may be referred to herein as macropixels.

It will be appreciated that in general the high-detail region may be arranged in different positions in the display from image frame to image frame, and FIG. 1 is merely an illustrative example of a foveation pattern where the high-detail region happens to be in the center. Moreover, any number of contiguous display elements arranged in any suitable size and shape may be operated to produce the same output in any given region. For instance, blocks of 3×3 display elements or 5×5 display elements may be operated in such a manner in a given region of the image. Similarly, any number of regions with different levels of detail may be generated in a given image, and the techniques described herein are not limited to the three regions shown in the example of FIG. 1.

In the example of FIG. 1, a display element in the display is addressed when a gate signal 101 and a display signal 102 are both provided to the display element. As shown, the gate signals may be provided along rows of the display, and the display signals provided along columns of the display. An individual display element may thereby be addressed by providing a gate signal to the row in which the display element is located, and by providing a display signal to the column in which the display element is located. According to some embodiments, each gate signal may be a digital value (e.g., 0 or 1) that indicates whether or not the row is active, and each display signal may be an analog signal indicative of how the display element is to be operated (e.g., indicates a brightness level). In a typical display, an image is produced by sequentially activating the rows of the display via successive gate signals, and while each gate signal activates a given row, display signals are provided along successive columns indicating how each display element is to be operated. In this manner, each display element is operated to produce light (e.g., from top-left to bottom-right, element-by-element, row-by-row).

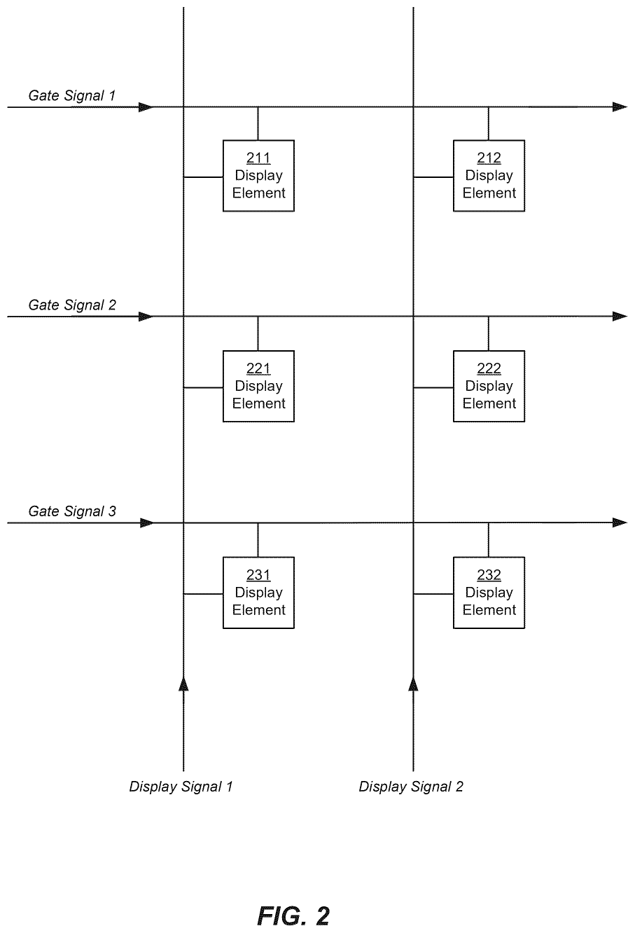

FIG. 2 depicts this type of addressing in more detail, according to some embodiments of the present disclosure. In the example of FIG. 2, six display elements are depicted, and are arranged in three different rows and two different columns, which may represent part of a larger array of display elements having many rows and columns. Each of the display elements 211, 212, 221, 222, 231 and 232 may be activated by providing both a display signal input and a gate signal input along the columns and rows, respectively, as shown in FIG. 2. For example, display element 211 is activated when gate signal 1 is active and display signal 1 is active, and display element 211 is otherwise not activated. As described above, typically the display elements in a display are activated one by one in succession to produce a single image frame. For example, in the example of FIG. 2, the gate signal 1 may be set active and display signal 1 provided so that display element 211 is operated according to the display signal 1; then the display signal 1 may stop and display signal 2 may be provided, while the gate signal 1 remains active, so that display element 212 is operated according to the display signal 2; and so forth.

Some display drivers orchestrate this process of addressing row by row by generating successive gate signals for each row. In some arrangements, the gate signals are generated by a circuit that sends an active signal to a desired row by receiving a control input (e.g., clock signal) associated with that row.

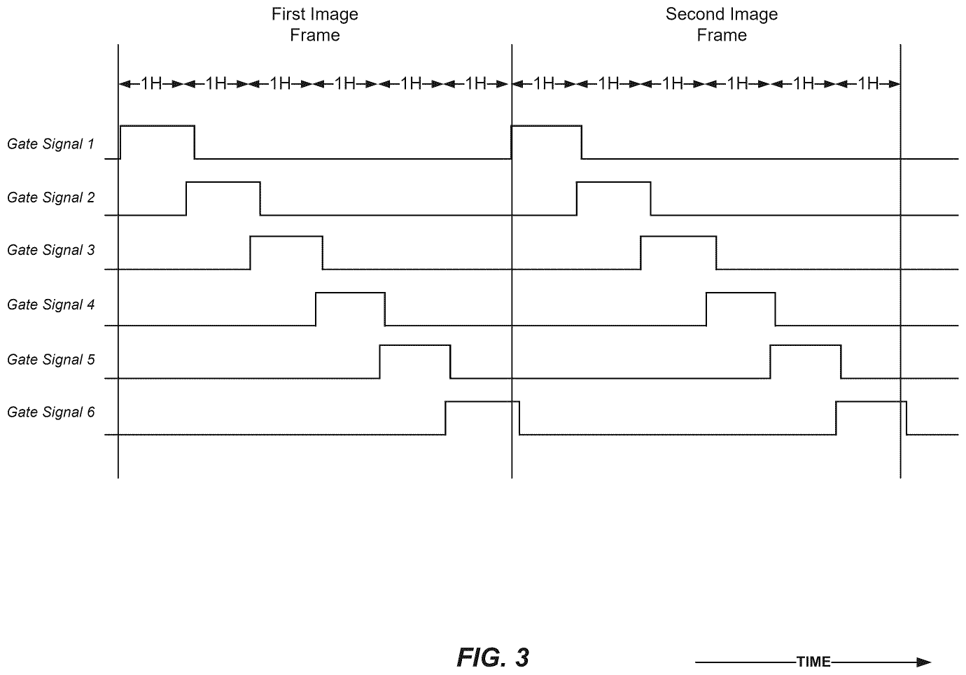

FIG. 3 depicts one approach to driving rows of display elements in a display, according to some embodiments of the present disclosure. For purposes of comparison, the gate signals depicted in FIG. 3 are produced in a process in which each row of display elements is driven independently, one at a time. Such a process may be used to produce portions of a foveated display image (e.g., when producing the high detail region shown in FIG. 1), although as described above some display systems are always operated in this manner.

In the example of FIG. 3, during each display period (labeled “H” in FIG. 3 and in subsequent drawings) one of the gate signals is driven high to activate an associated row of display elements, as shown in FIG. 2. In this example, there are only six rows of display elements, although this same approach could be performed for any number of rows. In the example of FIG. 3, two images may be produced in this illustrative small display in succession by driving each of the rows in turn to produce a first image, then driving each of the rows again in turn to produce a second image, etc. During each display period, each column of display elements may be driven one by one so that, during each display period, each display element in a row is controlled to output a desired color and/or brightness.

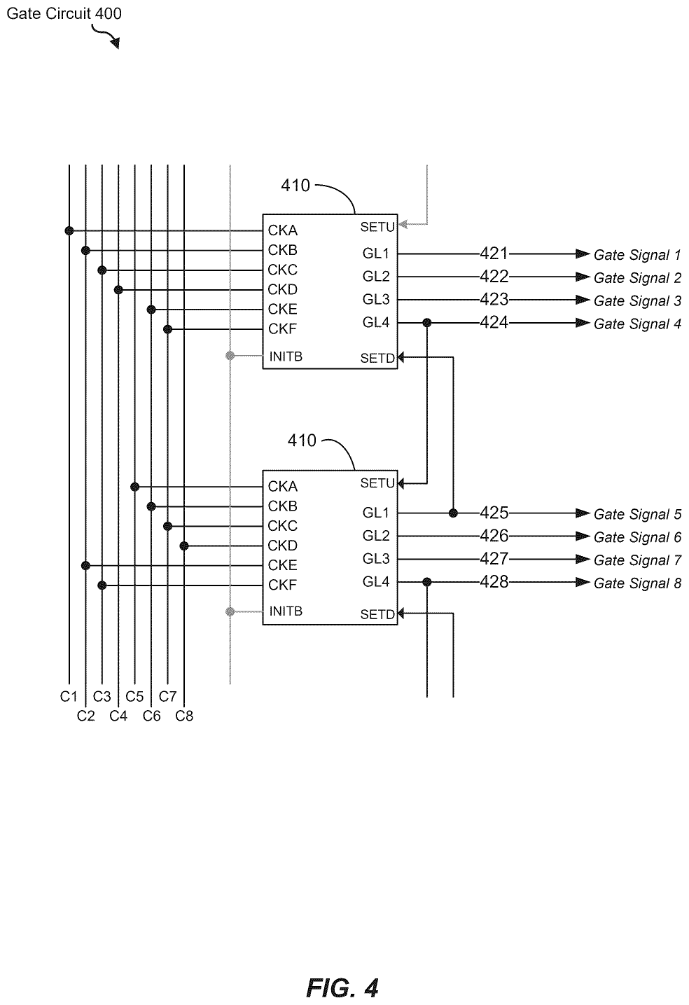

FIG. 4 depicts a portion of an illustrative display system configured to adjust a number of rows of display elements that are driven simultaneously to more efficiently drive all the rows to produce a foveated display image, according to some embodiments of the present disclosure. In the example of FIG. 4, a plurality of gate driver units 410 are each coupled to some, but not all, of eight clock signal lines labeled C1-C8. For instance, one gate driver unit 410 is coupled to the clock signal lines C1, C2, C3, C4, C6 and C7 (via clock inputs CKA, CKB, CKC, CKD, CKE and CKF, respectively), whereas the other gate driver 410 is coupled to the clock signal lines C2, C3, C5, C6, C7 and C8 (via clock inputs CKA, CKB, CKC, CKD, CKE and CKF, respectively). The upper gate driver unit produces gate signal outputs 421, 422, 423 and 424, whereas the lower gate driver unit produces gate signal outputs 425, 426, 427 and 428.

As will be described further below, by controlling each of the signals along clock signal lines C1-C8, each of the eight gate signals 1-8 may be produced in at least combinations of one and two gate signals simultaneously. Combinations of three, four, or more gate signals produced simultaneously may in principle be produced with this circuit, or with a circuit comprising more than eight gate signals, and in some cases gate driver units that have additional inputs beyond those in the example of gate driver units 410.

In the example of FIG. 4, any number of instances of the gate driver units 410 may be included and each pair of gate driver units may be coupled to the clock signal lines as shown in the display device, so that any number of rows of display signals may be driven by respective gate signals. In the example of FIG. 4, each gate driver unit 410 in the chain of gate driver units (two of which are shown in the drawing) enables successive gate drivers via each driver's SETU input when scanning top to bottom, or via each driver's SETD input when scanning bottom to top.

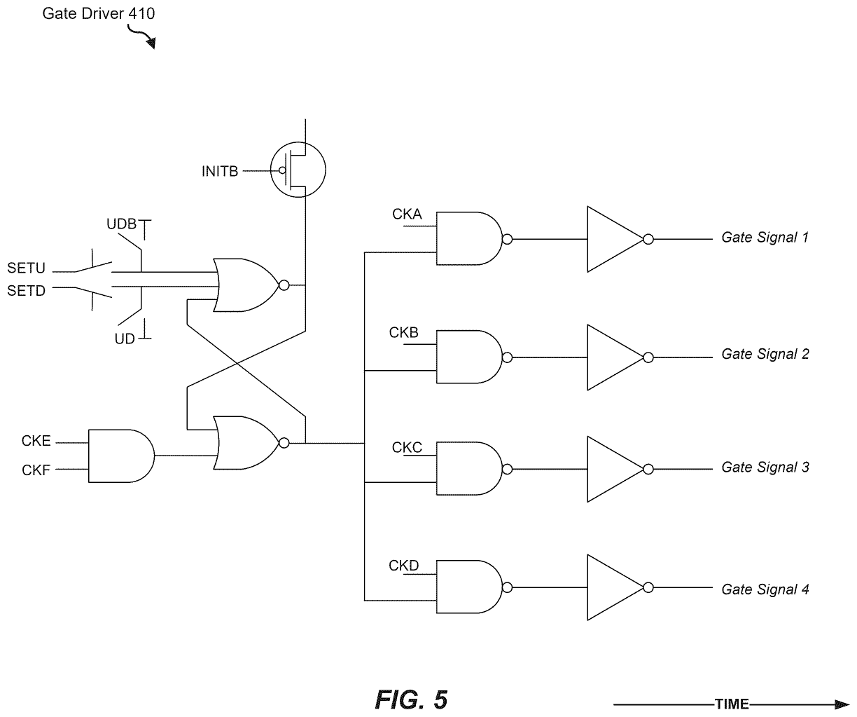

FIG. 5 depicts one illustrative implementation of the gate driver unit 410 shown in FIG. 4, according to some embodiments of the present disclosure. In the example of FIG. 5, each of the gate signals 1-4 are produced when a corresponding clock input is high (e.g., gate signal 1 is produced when the input to CKA is high), and when both CKE and CKF clock inputs are low. In the example of FIG. 5, INITB is an initial reset signal which causes all the gate signals 1-4 to be set low; UD and UDB are signals that may be set to dictate whether scanning from gate driver unit to gate driver units passes from top to bottom, or bottom to top; SETU is an activation signal when scanning top to bottom; and SETD is an activation signal when scanning bottom to top.

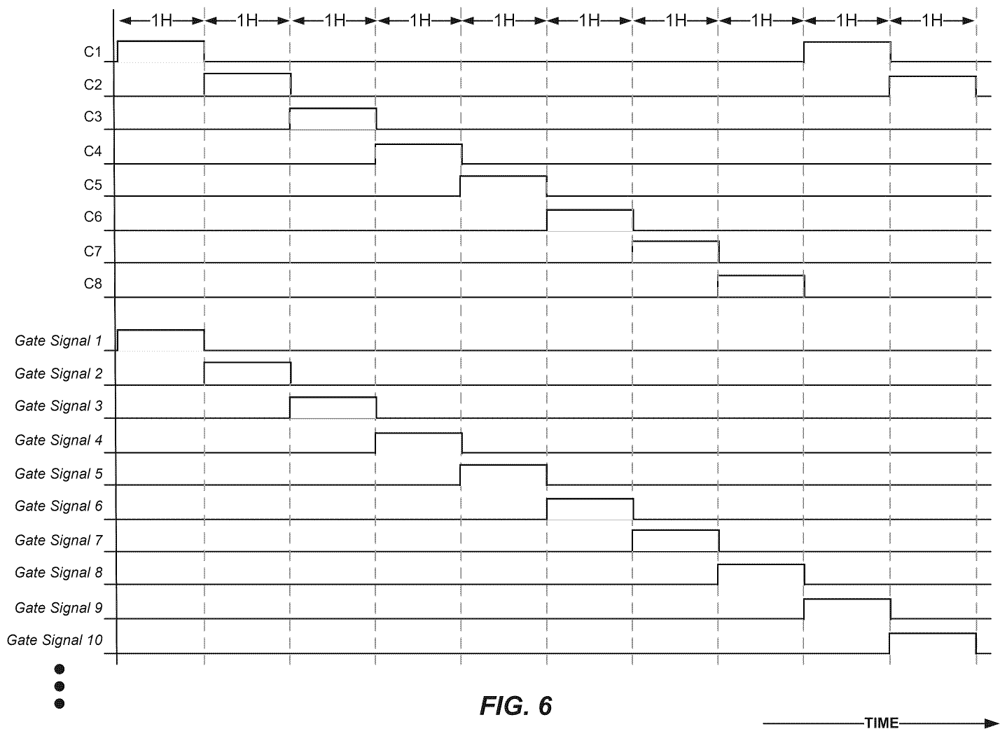

Returning to FIG. 4, it may be noted that when the clock inputs CKB and CKC of the lower gate driver unit 410 are connected to clock signal lines C6 and C7, which are also connected to the clock inputs CKE and CKF of the upper gate driver unit 410. As such, when any sequential pair of the clock inputs to the lower gate driver unit are activated (e.g., CKA and CKB, or CKB and CKC, etc.), this will inhibit output of any gate signals from the upper gate driver unit. This configuration provides for a variety of desired combinations of one, two, three, four, etc. gate signals to be produced simultaneously, as demonstrated in FIGS. 6, 7, 8, 9 and 10.

In the example of FIG. 6, one of each of the clock signals C1-C8 are activated in each display period (again, denoted as “H”), where after the final clock signal C8 is high, the first clock signal C1 is again driven high, and so forth. By arranging a chain of gate driver units 410 as shown in FIG. 4, a gate signal may be applied to one row of display elements in each display period. For instance, when C1 is high, the clock input CKA of the first gate driver unit is high, producing a gate signal output at 421. When C6 is high, the clock input CKE of the upper gate driver unit is high, and the clock input CKB of the lower gate driver unit is high. However, only the lower gate driver unit will produce an output gate signal (at 426) as high input to input CKE inhibits the upper gate driver unit from producing a gate signal output.

The behavior of FIG. 6 is the same as that shown in FIG. 3, but importantly can be controlled on a row-by-row basis to produce multiple gate signals at the same time, as desired. For instance, when controlling display elements to produce light according to a foveated display image, it may be desirable to activate multiple rows at the same time when operating multiple pixels (e.g., a macropixel) in a low detail region, and to activate single rows when operating pixels in a high detail region.

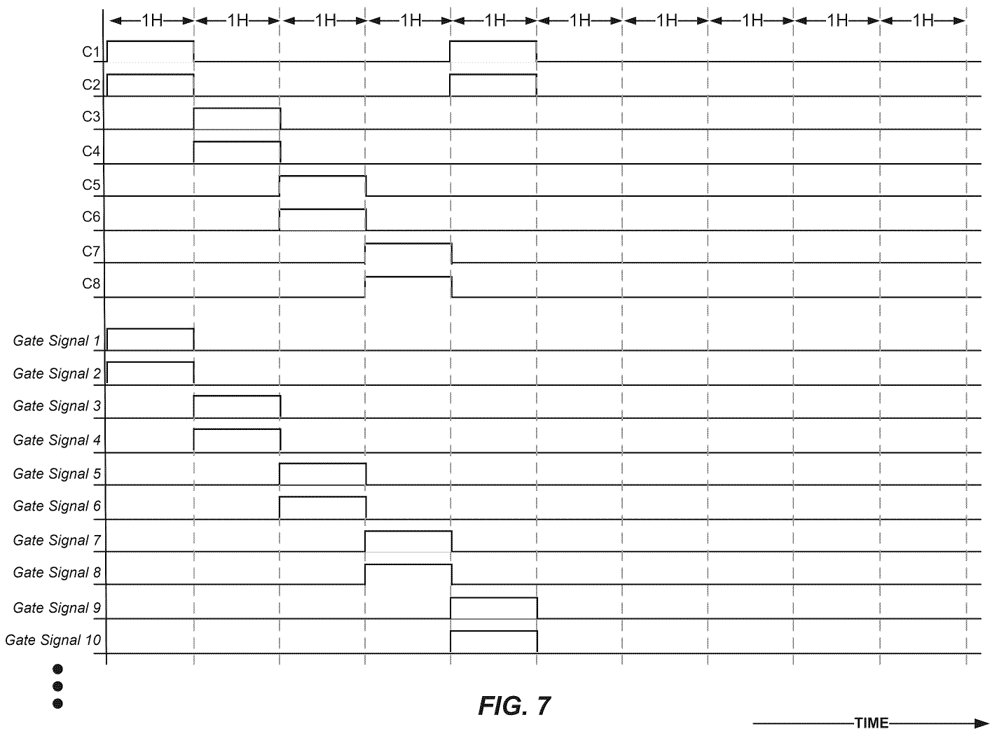

FIG. 7 is an example of modifying the phase of the clock signals C1-C8 to simultaneously send gate signals to two rows, according to some embodiments of the present disclosure. In the example of FIG. 7, clock signals C1 and C2 are both driven high in a first display period H, which produces gate signals outputs at 421 and 422. Similarly, in the next display period H, C3 and C4 are both driven high, which produces gate signals outputs at 423 and 424. It may be noted that, because of the temporal overlap of the gate signals, the same number of rows of display elements as in FIG. 6 may be operated in half the time compared with the example of FIG. 6. Therefore, as described above, generating gate signals in this manner may reduce the time to generate an image frame.

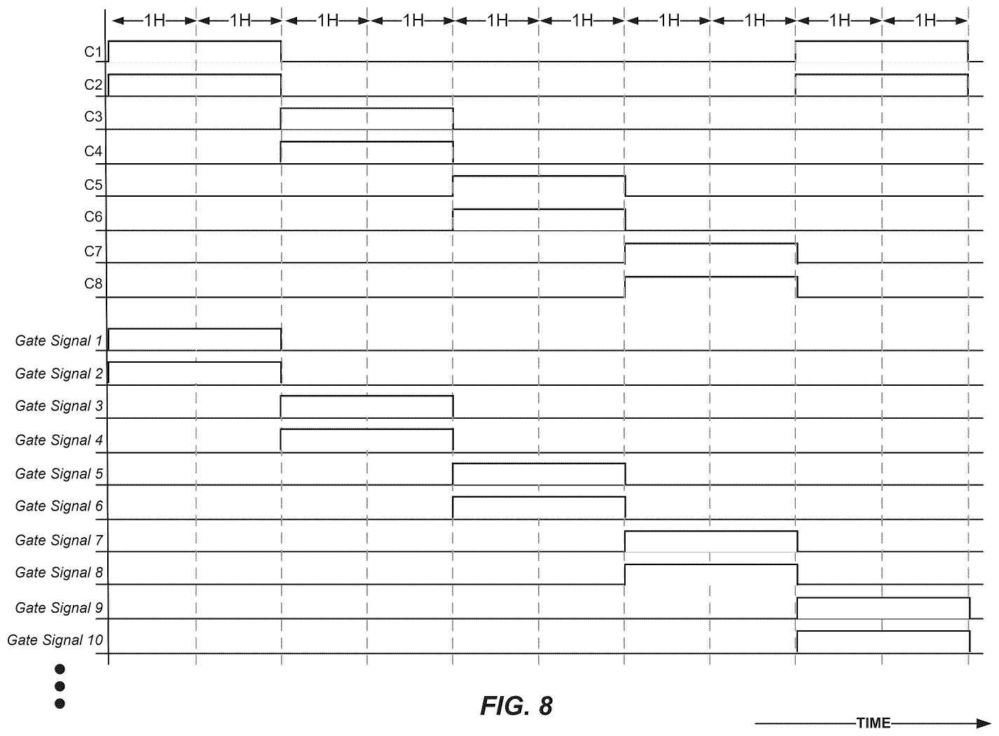

Alternatively, if a fixed image frame generation time is desirable when multiple gate signals are produced at the same time, the gate signals may be applied for multiple display periods, as shown in FIG. 8. In the example of FIG. 8, the same clock driving approach is used as in FIG. 7, except that the same signals are applied for longer so that the total time to drive all of the rows of display elements with the gate signals is the same as in the example of FIG. 6.

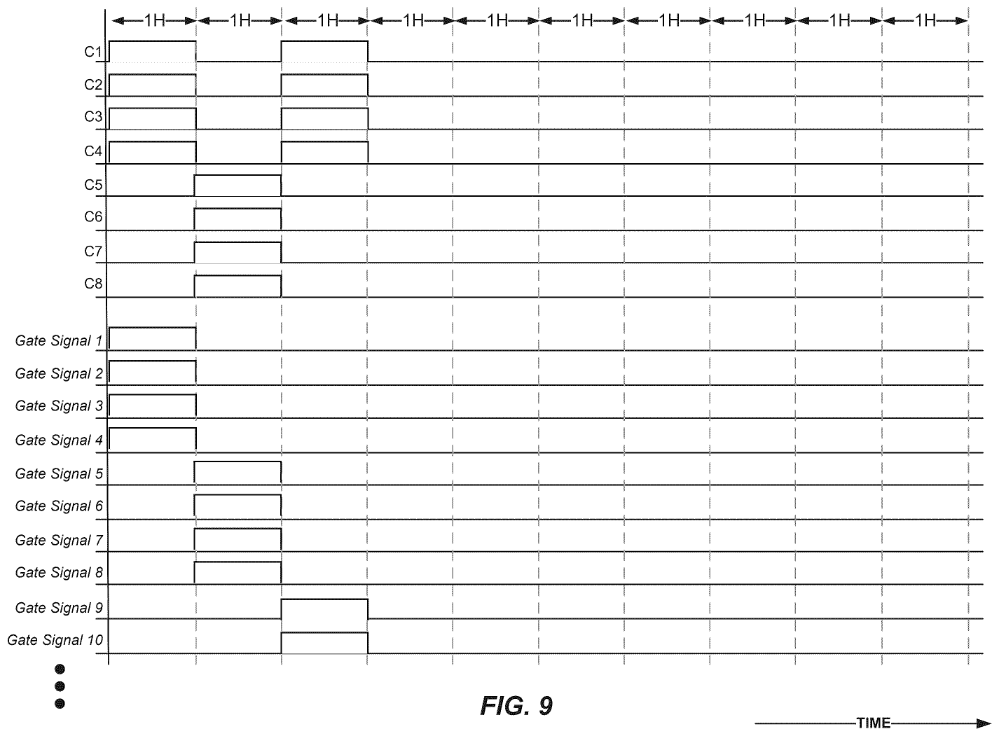

FIG. 9 is an example of modifying the phase of the clock signals C1-C8 to simultaneously send gate signals to four rows, according to some embodiments of the present disclosure. In the example of FIG. 9, clock signals C1, C2, C3 and C4 are all driven high in a first display period H, which produces gate signals outputs at 421, 422, 423 and 424. Similarly, in the next display period H, C5, C6, C7 and C8 are all driven high, which produces gate signals outputs at 425, 426, 427 and 428.

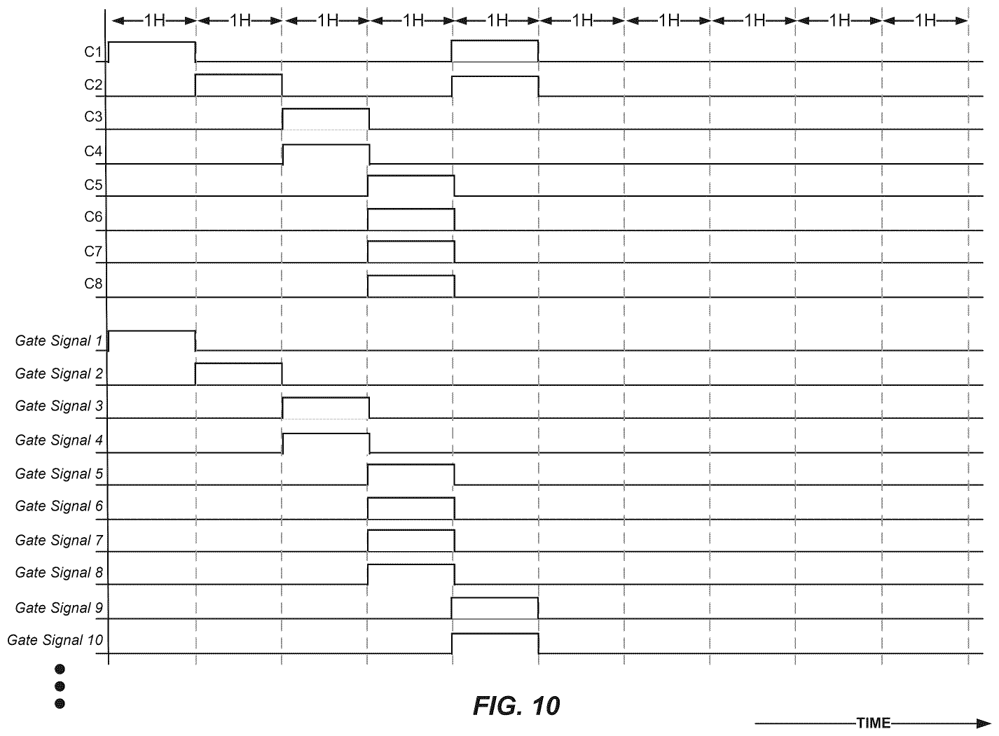

FIG. 10 is an example of modifying the phase of the clock signals C1-C8 to send gate signals to different number of rows in successive display periods, according to some embodiments of the present disclosure. In the example of FIG. 10, clock signals C1 and C2 are both driven high in first and second display periods, respectively, which produces gate signals at output at 421 in the first display period and output 422 in the second display period. In the next display period, C3 and C4 are both driven high, which produces gate signals outputs at 423 and 424 in the same display period. In the next display period, C5, C6, C7 and C8 are all driven high, which produces gate signals outputs at 425, 426, 427 and 428 in the same display period. The example of FIG. 10 demonstrates how control of the phase of each clock signal C1-C8 can control the number of gate signals produced in the same display period, and consequently how many rows of display elements are driven at the same time.

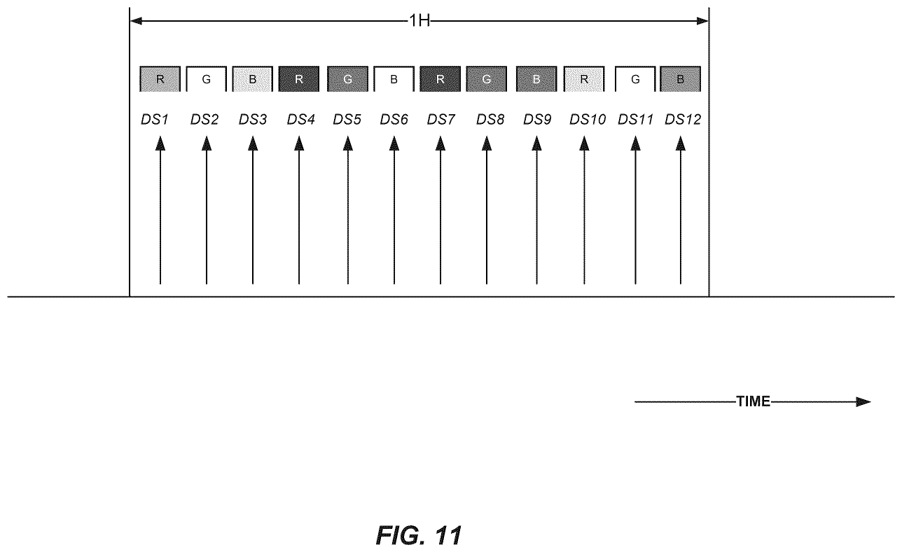

As described above, embodiments of the present disclosure may provide a display system comprising a plurality of demultiplexers configured to simultaneously relay display data to one or more columns of display elements of a display, where the plurality of demultiplexers includes demultiplexers configured to simultaneously relay display data to different number of columns at the same time. In contrast, other approaches may operate as shown in FIG. 11, in which a display signal (“DS”) is provided to each column of display elements one by one during a display period H (display signals DS1-DS12). In the example of FIG. 11, the display elements are sub-pixels configured to produce red (R), green (G) or blue (B) light at a brightness according to the received display signal when also driven by a gate signal. As described above, one approach to displaying an image frame is to drive each row one-by-one in successive display periods (as shown in FIG. 3), and drive each column one-by-one during each of these display periods, thereby addressing each display element one at a time. In some embodiments, different sub-pixels of each pixel (e.g., the red, green and blue sub-pixels of a first pixel, which receive display signals DS1, DS2 and SD3, respectively) may be driven at the same time. As such, the depicted timeline in FIG. 11 may be compressed by a factor of three.

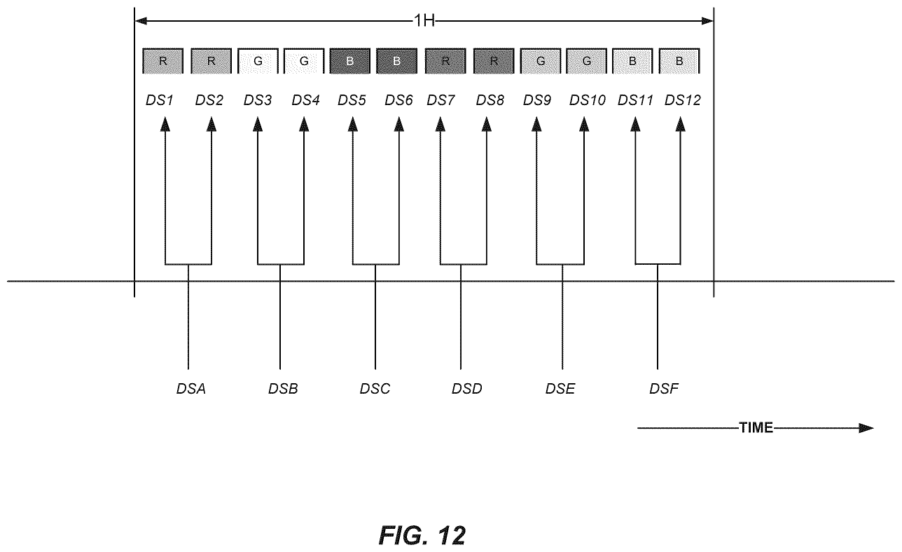

FIG. 12 depicts an improved approach to driving these columns of sub-pixels when driving two columns at once is desired. In the example of FIG. 12, six driving signals DSA, DSB, DSC, DSD, DSE and DSF are each demultiplexed into two display signals to produce display signals DS1-DS12, which are each provided to a pair of columns of sub-pixels. The physical arrangement of the columns of sub-pixels may not necessarily match that shown in FIG. 12, which is provided merely to demonstrate how multiple display signals may be generated to drive multiple columns of sub-pixels at the same time. The driving signals, and the display signals generated by the demultiplexers, may be digital signals, or may be analog signals that represent a digital value (e.g., an analog signal representing a value from 0 to 255 corresponding to a sub-pixel brightness).

In some embodiments, columns of sub-pixels of different colors may be driven at the same time. For instance, one column of red sub-pixels may be driven in the same time frame as one column of green sub-pixels and one column of blue sub-pixels. The other columns of sub-pixels may then all be driven in a subsequent time frame.

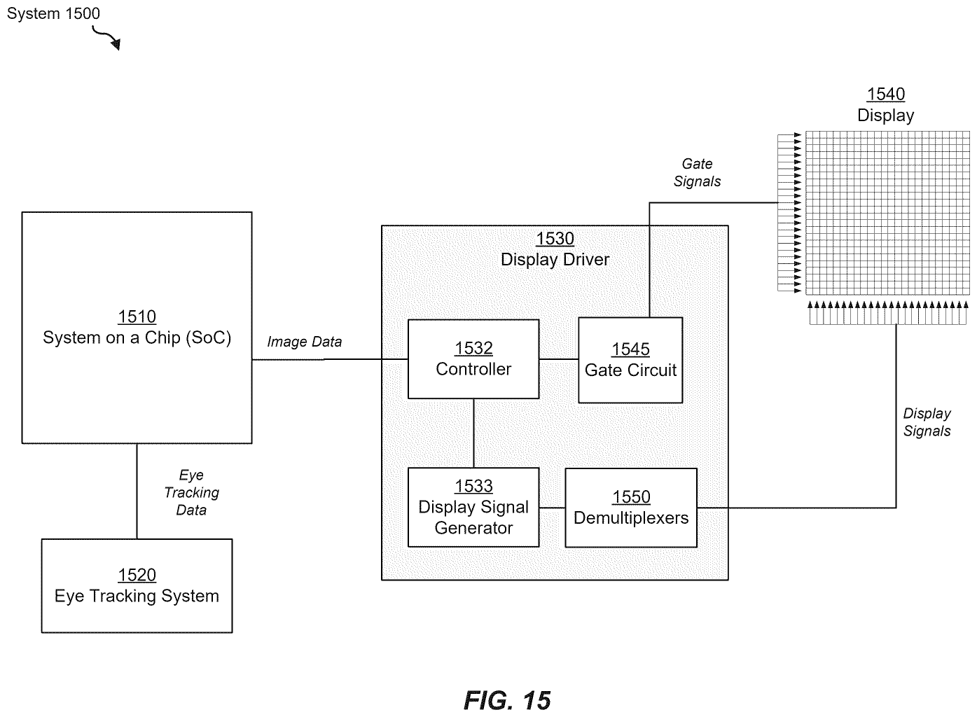

According to the techniques described herein, a display system may comprise one or more demultiplexers that are each configured to demultiplex an input display signal into multiple identical output display signals and send those output display signals to multiple columns of display elements (e.g., columns of sub-pixels). An example of such a system is described below with respect to FIG. 15. Each of the one or more demultiplexers may be configured to demultiplex an input display signal into a different number of output display signals. For instance, a set of demultiplexers may include a first demultiplexer configured to demultiplex an input display signal into two output display signals, a second demultiplexer configured to demultiplex an input display signal into three output display signals, a third demultiplexer configured to demultiplex an input display signal into four output display signals, etc. The display system may also be configured to send an input display signal directly to a column of display elements when it is desirable to drive only a single column without driving other columns.

According to some embodiments, the display system may select one of the demultiplexers based on image data indicative of one of the demultiplexers. This image data may be an analog signal or a digital signal. For example, image data may comprise a digital value (e.g., corresponding to one of the demultiplexers, followed by image data describing the value with which to drive the demultiplexer (e.g., a digital value from 0-255 indicating the brightness of a sub-pixel), followed by another digital value corresponding to another of the demultiplexers (which may be the same or different demultiplexer), followed by image data describing another value with which to drive that demultiplexer, etc. In some embodiments, image data that describes a value with which to drive a selected demultiplexer may be a digital value that is converted to an analog signal and input to the demultiplexer, whereas the image data that indicates which demultiplexer is selected is a digital value that instructs the display system which multiplexer to select. Alternatively, the image data may be an analog signal, wherein part of the analog signal indicates which demultiplexer is selected is a digital value and part of the analog signal describes the value with which to drive the selected demultiplexer.

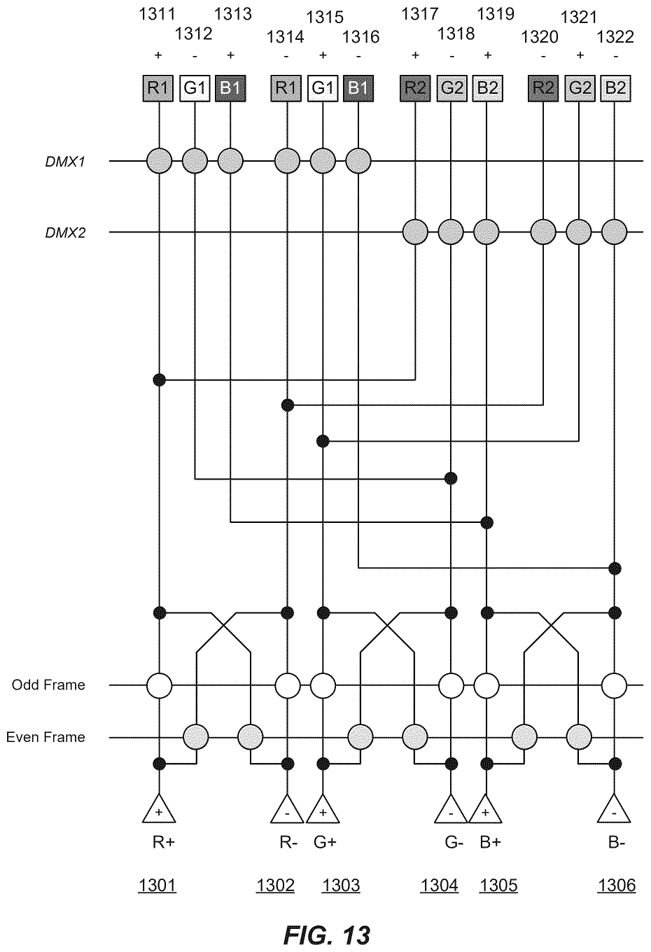

FIG. 13 depicts an example of a 1:2 demultiplexer, according to some embodiments of the present disclosure. In the example of FIG. 13, input display signals may be provided to the inputs R+, R−, G+, G−, B+ and/or B−, and the depicted circuit pathways, in conjunction with operation of the DMX1, DMX2, odd frame, and even frame switches, route each input display signals to a pair of columns of sub-pixels. The demultiplexer of FIG. 13 is configured to drive each of the depicted twelve columns of sub-pixels over two frames, as described below.

The illustrative demultiplexer of FIG. 13 is configured for a liquid crystal display (LCD) in which at least alternating columns of sub-pixels have opposite polarity to one another. As a result, signals provided to each sub-pixel is configured with the appropriate polarity for the destination sub-pixel.

One illustrative way to operate the circuit of FIG. 13 is as follows. In a first frame, a display signal R1 is provided to input 1301 with positive polarity and to input 1302 with negative polarity. In the first frame, the odd frame switch is open, and the even frame switch is closed. In addition, the DMX1 switches are open and the DMX2 switches are closed. As a result, the columns of sub-pixels 1311 and 1314 receive the same indication of brightness R1, with column of sub-pixels 1314 receiving an negative polarity version and with column of sub-pixels 1311 receiving a positive polarity version. Also in the first frame, a display signal G1 is provided to input 1303 with a positive polarity and to input 1304 with a negative polarity, causing the columns of sub-pixels 1312 and 1315 receive the same indication of brightness G1. Also in the first frame, a display signal B1 is provided to input 1305 with a positive polarity and to input 1306 with a negative polarity, causing the columns of sub-pixels 1313 and 1316 receive the same indication of brightness B1. As a result of this process, pairs of columns of sub-pixels are driven with the same input values in a single frame.

In a second frame, the odd frame switch is closed, the even frame switch is open, the DMX1 switches are closed and the DMX2 switches are open. Display signals R2, G2 and B2 may be provided to the inputs 1301-1306 with appropriate polarities in this frame, to drive pairs of the columns of sub-pixels 1317-1322 with the same input values in a single frame.

Other patterns of applying display signals to the inputs 1301-1306 may also be envisioned, as the above should not be considered a limiting approach to operating the circuit of FIG. 13. Similarly, the pattern of switches DMX1 and DMX2 may also be adjusted to change the routing behavior of the circuit. In some cases, display signals with different values (not just different polarities) may be provided to a pair of inputs associated with the same color (e.g., inputs 1301 and 1302, or inputs 1303 and 1304, or inputs 1305 and 1306) in the same frame. Thus, it is not necessarily the case that the same indication of brightness is provided to multiple columns of sub-pixels of the same color in the same frame. In each configuration, however, two columns of sub-pixels of the same color will nonetheless each be driven in the same frame.

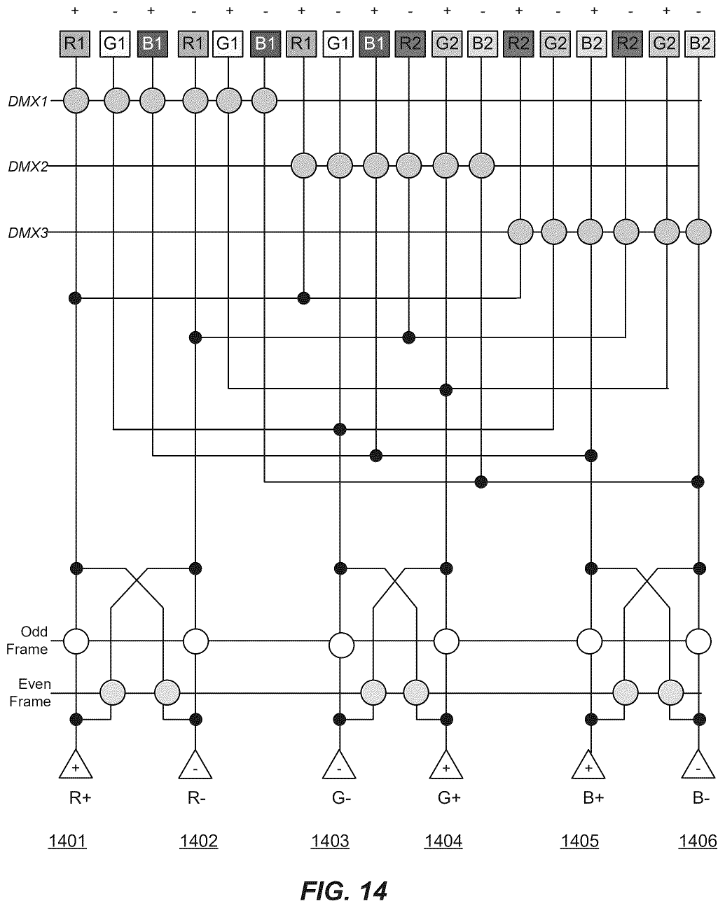

FIG. 14 depicts an example of a 1:3 demultiplexer, according to some embodiments of the present disclosure. In the example of FIG. 14, input display signals may be provided to the inputs R+, R-, G+, G-, B+ and/or B-, and the depicted circuit pathways, in conjunction with operation of the DMX1, DMX2, DMX3, odd frame, and even frame switches, route each input display signals to a pair of columns of sub-pixels. The demultiplexer of FIG. 14 is configured to drive each of the depicted eighteen columns of sub-pixels over three frames, as described below.

One illustrative way to operate the circuit of FIG. 14 is as follows. In a first frame, a display signal R1 is provided to input 1401 (positive polarity) and input 1402 (negative polarity); display signal G1 to input 1403 (negative polarity) and input 1404 (positive polarity); display signal B1 to input 1405 (positive polarity) and input 1406 (negative polarity). In this frame, the DMX1 switches are open and the DMX2 and DMX3 switches are closed. In a second frame, a display signal R1 is provided to input 1401 (positive polarity) and a display signal R2 provided to input 1402 (negative polarity); display signal G1 to input 1403 (negative polarity) and display signal G2 to input 1404 (positive polarity); display signal B1 to input 1405 (positive polarity) and display signal B2 to input 1406 (negative polarity). In this frame, the DMX2 switches are open and the DMX1 and DMX3 switches are closed. In a third frame, a display signal R2 is provided to input 1401 (positive polarity) and input 1402 (negative polarity); display signal G2 to input 1403 (negative polarity) and input 1404 (positive polarity); display signal B2 to input 1405 (positive polarity) and input 1406 (negative polarity). In this frame, the DMX3 switches are open and the DMX1 and DMX2 switches are closed.

As with the circuit of FIG. 13, other patterns of applying display signals to the inputs 1401-1406 may also be envisioned, and the above should not be considered a limiting approach to operating the circuit of FIG. 14. Similarly, the pattern of switches DMX1, DMX2 and DMX3 may also be adjusted to change the routing behavior of the circuit.

Other demultiplexers may be envisioned for 1:4, 1:5, etc. demultiplexing by following the techniques described above and shown in FIGS. 13 and 14.

FIG. 15 depicts an illustrative system 1500 that may be operated accordingly to the techniques described herein, according to some embodiments of the present disclosure. System 1500 may for instance be part of a wearable device, such as an Artificial-Reality system, examples of which are described below.

In the example of FIG. 15, the system 1500 is controlled in part by SoC 1510, which generates image data for display on display 1540. Control of the display 1540 is provided by display driver 1530, which receives image data from the SoC 1510 and generates gate signals and display signals to address display elements in the display 1540 as described above. The gate signals are generated in the example of FIG. 15 by gate circuit 1545, which may for instance be implemented as gate circuit 400 shown in FIG. 4.

According to some embodiments, the image data provided by SoC 1510 comprises digital values indicating the colors of a plurality of display elements of the display 1540. The number of such digital values for a single image frame may be less than the number of display elements in the display since in a foveated display implemented as described herein, display signals may be provided to multiple columns at the same time to address multiple display elements at the same time in conjunction with multiple gate signals. As a result, a data stream representing an image frame may be smaller in size than are necessary when each display element is addressed individually, potentially leading to improved efficiency of display rendering.

In some embodiments, the image data provided by SoC 1510 may also comprise information regarding the foveated layout of the image frame to be rendered, which informs the controller 1532 how to operate the gate circuit (e.g., how to control the frequency of the Nx clock of the gate circuit) to render the image frame by, at least in part, activating multiple rows of the display 1540 at the same time by simultaneously providing multiple gate signals to display elements of the display. In some embodiments, information regarding the foveated layout of the image frame to be rendered may comprise the coordinate position in the image frame of various locations in the foveated layout, such as the center of a region (e.g., a high-detail, mid-detail or low-detail region), the corner of a region, etc. Additionally, or alternatively, the information regarding the foveated layout of the image frame to be rendered may comprise a display element density for a particular region, a size of the region (e.g., horizontal and/or vertical size) and/or any other information indicative of which display elements are to be addressed simultaneously and thereby operated in the same manner.

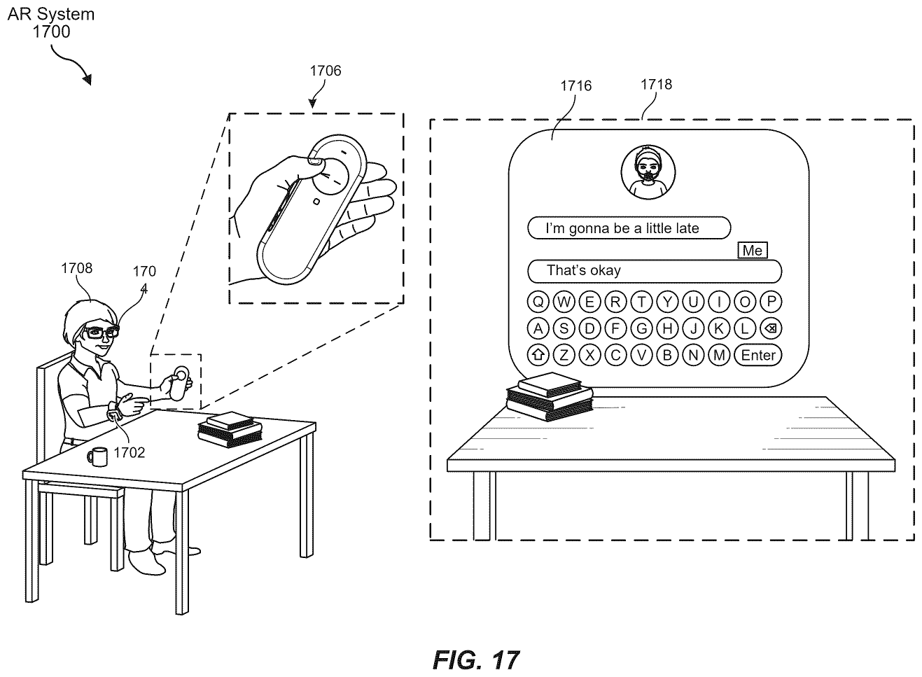

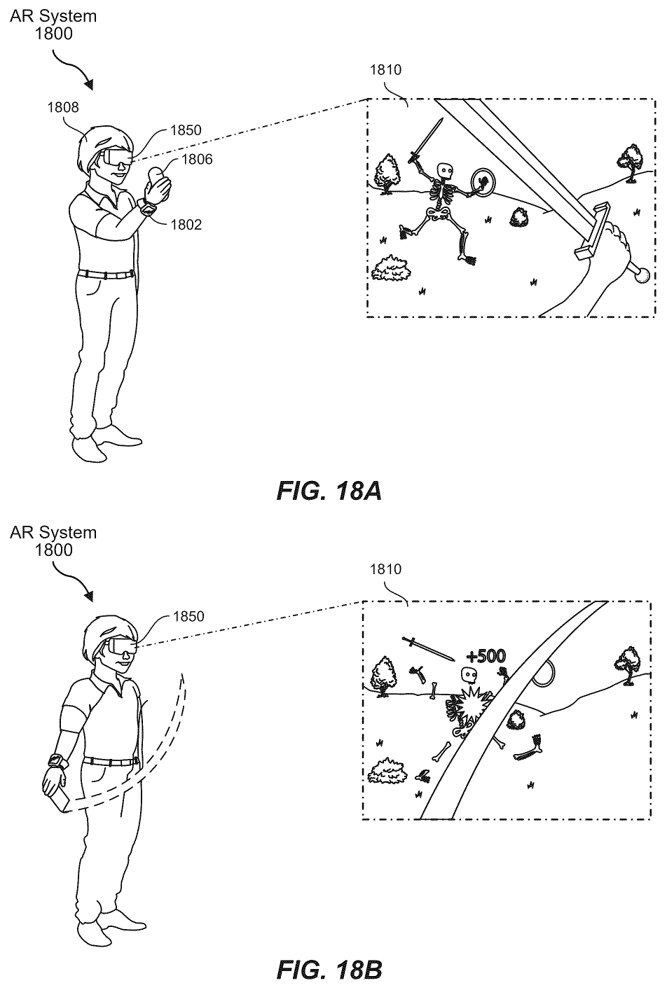

In the example of FIG. 15, the eye tracking system 1520 may detect and measure the position of one or both eyes of a wearer of the device comprising system 1500. Illustrative eye tracking systems are described below in relation to FIGS. 17 and 18. The eye tracking system 1520 may provide eye tracking data to the SoC 1510, which comprises an indication of a position of the user's eye or eyes, with which the SoC generates the image data to send to the display driver 1530. For instance, the SoC 1510 may determine the position of a high-detail region of an image frame based on a position of the eye or eyes, and generate image data accordingly as described above.

In the example of FIG. 15, controller 1532 is configured to generate clock signals to drive the gate circuit 1545 (e.g., clock signals along clock signal lines C1-C8 in FIG. 4), which in turn outputs gate signals to one or more rows of display elements of the display 1540. The controller 1532 is also configured to control the display signal generator 1533 to produce display signals, which address display elements in the display 1540 along with the gate signals produced by the gate circuit 1531. In some embodiments, the controller 1532 may produce the display signals and the gate signals in a synchronized manner (e.g., by operating the display signal generator according to the same clock signal period as the gate circuit 1545). In some embodiments, the display signal generator 1533 may comprise a digital to analog converter configured to convert digital values indicating a color or brightness (e.g., received from the SoC 1510) to one or more analog display signals. For example, an RGB digital value may be converted into one or multiple (e.g., three) analog display signals that address a display element (e.g., a pixel or a sub-pixel) of the display 1540. Although not shown in FIG. 15, the controller 1532 may also be configured to control which of the columns a display signal is routed to.

The demultiplexers 1550 may receive display signals from the display signal generator 1533 and demultiplex those display signals into multiple display signals as described above. Moreover, the display signal generator 1533 may route the display signals to a selected one of the demultiplexers 1550 as described above (e.g., based on part of the image data indicating which multiplexer to use to generate display signals from a given portion of the image data). In some embodiments, the demultiplexers 1550 may include the demultiplexers shown in FIG. 13 and in FIG. 14, in addition to one or more other demultiplexers.

Although the elements of FIG. 15 are depicted as separate sub-systems, it will be appreciated that these elements need not be implemented in such a manner. For example, the display driver 1530 may be implemented as an integrated circuit that implements at least the gate circuit 1531, the controller 1532, the display signal generator 1533 and demultiplexers 1550. In some embodiments, the display driver 1530 may be viewed as a controller that performs the operations of the gate circuit 1531, the controller 1532, the display signal generator 1533 and demultiplexers 1550 described above.

Features from any of the embodiments described herein may be used in combination with one another in accordance with the general principles described herein. These and other embodiments, features, and advantages will be more fully understood upon reading the following detailed description in conjunction with the accompanying drawings and claims.

It will be appreciated that references herein to driving multiple rows or columns of display elements at the “same time” or “simultaneously” refer to operations that cause each of the rows and/or columns to be addressed at the same time. The signals that drive the rows and/or columns need not necessarily be initiated or end at the same time to be considered to be produced at the “same time” or “simultaneously.” For example, two signals that both trigger at their leading edges at the same time may end at different times without affecting their simultaneous addressing. Similarly, two signals that both trigger at their trailing edges at the same time may start at different times without affecting their simultaneous addressing.

### EXAMPLE EMBODIMENTS

Example 1. A system comprising: a plurality of addressable display elements arranged into a plurality of rows and a plurality of columns; a plurality of clock signal lines; a plurality of gate driver units, each gate driver unit coupled to one or more clock signal lines of the plurality of clock signal lines and configured to send a gate signal to one or more of the plurality of rows of display elements based on clock signals provided along the one or more clock signal lines; and a controller configured to generate the clock signals, thereby causing the plurality of gate driver units to send gate signals to respective rows of the plurality of rows of display elements, wherein the clock signals are controlled, according to a foveated display pattern, to adjust a number of gate signals that are simultaneously sent to the respective rows.

Example 2. The system of example 1, wherein the controller is configured to: generate the clock signals during a first display period, thereby causing a first gate driver unit of the plurality of gate driver units to send the gate signal to one or more of the plurality of rows of display elements during the first display period; and send a respective display signal to each of the plurality of columns of display elements during the first display period.

Example 3. The system of any of examples 1-2, wherein the controller is configured to, when the foveated display pattern includes a macropixel: generate the clock signals during the first display period, thereby causing the first gate driver unit of the plurality of gate driver units to simultaneously send the gate signal to at least two of the plurality of rows of display elements during the first display period; and simultaneously send respective display signals to at least two of the plurality of columns of display elements during the first display period.

Example 4. The system of any of examples 1-3, wherein the respective display signals simultaneously sent to the at least two of the plurality of columns of display elements during the first display period are the same display signal.

Example 5. The system of any of examples 1-4, wherein: the first gate driver unit of the plurality of gate driver units simultaneously sends the gate signal to four of the plurality of rows of display elements during the first display period; and the controller is further configured to simultaneously send the same display signal to four of the plurality of columns of display elements during the first display period.

Example 6. The system of any of examples 1-5, wherein the plurality of gate driver units includes a first gate driver having a plurality of clock inputs coupled to a first subset of the plurality of clock signal lines, and a second gate driver having the plurality of clock inputs coupled to a second subset of the plurality of clock signal lines, the second subset being different from the first subset.

Example 7. The system of any of examples 1-6, wherein at least one of the plurality of clock inputs of a respective gate driver of the plurality of gate driver units enables or disables the respective gate driver with respect to sending one or more gate signals.

Example 8. The system of any of examples 1-7, wherein the plurality of addressable display elements comprises a plurality of pixels and/or a plurality of sub-pixels.

Example 9. The system of any of examples 1-8, wherein the controller, the plurality of gate driver units and the plurality of clock signal lines are implemented as an integrated circuit.

Example 10. A method comprising: sending, by a first gate driver unit receiving first clock signals from a first subset of a plurality of clock signal lines, a gate signal simultaneously to each of a first number of rows of a plurality of display elements; sending, by a second gate driver unit receiving second clock signals from a second subset of the plurality of clock signal lines, different from the first subset, a gate signal simultaneously to each of a second number of rows of the plurality of display elements, wherein the second number of rows is different from the first number of rows.

Example 11. The method of example 10, further comprising adjusting a phase of the first clock signals to produce the second clock signals.

Example 12. The method of any of examples 10-11, further comprising generating the first clock signals and the second clock signals by a controller according to image data.

Example 13. The method of any of examples 10-12, wherein the plurality of display elements are arranged in a plurality of columns and a plurality of rows, and wherein the method further comprises simultaneously directing the gate signal to each of the first number of rows of the plurality of display elements and directing a display signal to one or more of the plurality of columns of display elements, thereby simultaneously directing both the display signal and the gate signal to one or more display elements.

Example 14. A system comprising: a plurality of addressable display elements arranged into a plurality of rows and a plurality of columns; and a controller comprising a plurality of demultiplexers and configured to, according to image data received by the controller: simultaneously relay, by a first demultiplexer of the plurality of demultiplexers, first display data to a first number of the plurality of columns of display elements; and subsequent to relaying the first display data to the first number of the plurality of columns of display elements, simultaneously relay, by a second demultiplexer of the plurality of demultiplexers, second display data to a second number of the plurality of columns of display elements, different from the first number of the plurality of columns of display elements.

Example 15. The system of example 14, wherein the image data comprises a plurality of demultiplexing indicators, and wherein the controller is configured to select one of the plurality of demultiplexers to receive display data based on one of the plurality of demultiplexing indicators.

Example 16. The system of any of examples 14-15, wherein the controller is configured to, based on the image data comprising a first demultiplexing indicator, first image data, a second demultiplexing indicator and second image data, send the first display data to the first demultiplexer based on the first demultiplexing indicator and the first image data, and send the second display data to the second demultiplexer based on the second demultiplexing indicator and the second image data.

Example 17. The system of any of examples 14-16, wherein the first number of the plurality of columns of display elements is greater than 1, and wherein the second number of the plurality of columns of display elements is 1.

Example 18. The system of any of examples 14-17, wherein the controller is configured to generate the first display data and the second display data based on the image data at least in part using a digital to analog converter.

Example 19. The system of any of examples 14-18, wherein the plurality of columns of display elements are configured with alternating polarity, and wherein the first demultiplexer comprises: a first input configured to route a first portion of the first display data to a first column of the plurality of columns of display elements; and a second input configured to route a second portion of the first display data to a second column of the plurality of columns of display elements, the second column being adjacent to and having opposite polarity to the first column.

Example 20. The system of any of examples 14-19, wherein the controller is configured to generate the first portion of the first display data as a polarity inverted version of the second portion of the first display data.

Example 21. The system of any of examples 14-20, wherein the first display data and the second display data are analog data signals.

Example 22. A method comprising: simultaneously relaying, by a first demultiplexer of a plurality of demultiplexers, first display data to a first number of a plurality of columns of display elements of a display; and subsequent to relaying the first display data to the first number of the plurality of columns of display elements, simultaneously relaying, by a second demultiplexer of the plurality of demultiplexers, second display data to a second number of the plurality of columns of display elements, different from the first number of the plurality of columns of display elements.

Example 23. The method of example 22, wherein the first demultiplexer and the second demultiplexer are implemented by different portions of circuitry within a display driver integrated circuit.

Example 24. The method of any of examples 22-23, further comprising, by a controller according to image data comprising a plurality of demultiplexing indicators, selecting one of a plurality of demultiplexers that includes the first demultiplexer and the second demultiplexer to receive display data based on one of the plurality of demultiplexing indicators.

Example 25. The method of any of examples 22-24, herein the first number of the plurality of columns of display elements is greater than 1, and wherein the second number of the plurality of columns of display elements is 1.

Example 26. The method of any of examples 22-25, wherein relaying the first display data to the first number of the plurality of columns of display elements comprises relaying the first display data to multiple of the plurality of columns of display elements configured to produce the same color of light.

Example 27. The method of any of examples 22-26, wherein the color of light is red, green or blue.

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed- or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

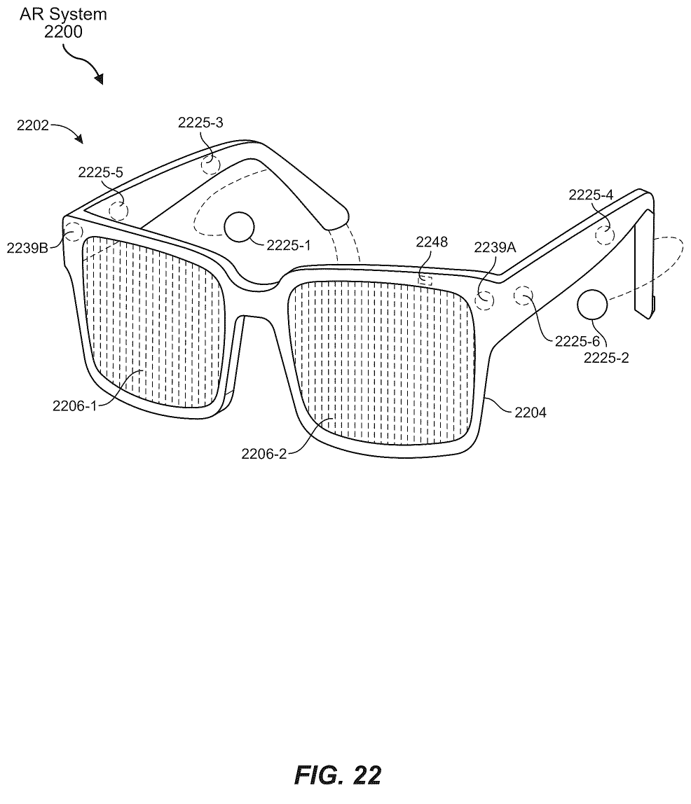

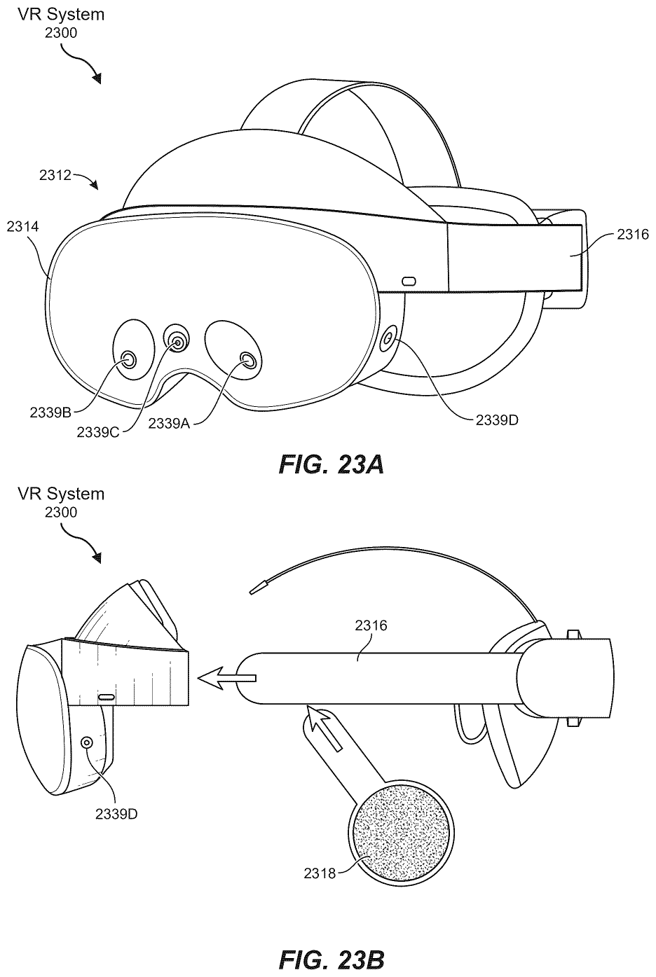

AR systems may be implemented in a variety of different form factors and configurations. Some AR systems may be designed to work without near-eye displays (NEDs). Other AR systems may include a NED that also provides visibility into the real world (such as, e.g., augmented-reality system 2200 in FIG. 22) or that visually immerses a user in an artificial reality (such as, e.g., virtual-reality system 2300 in FIGS. 23A and 23B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

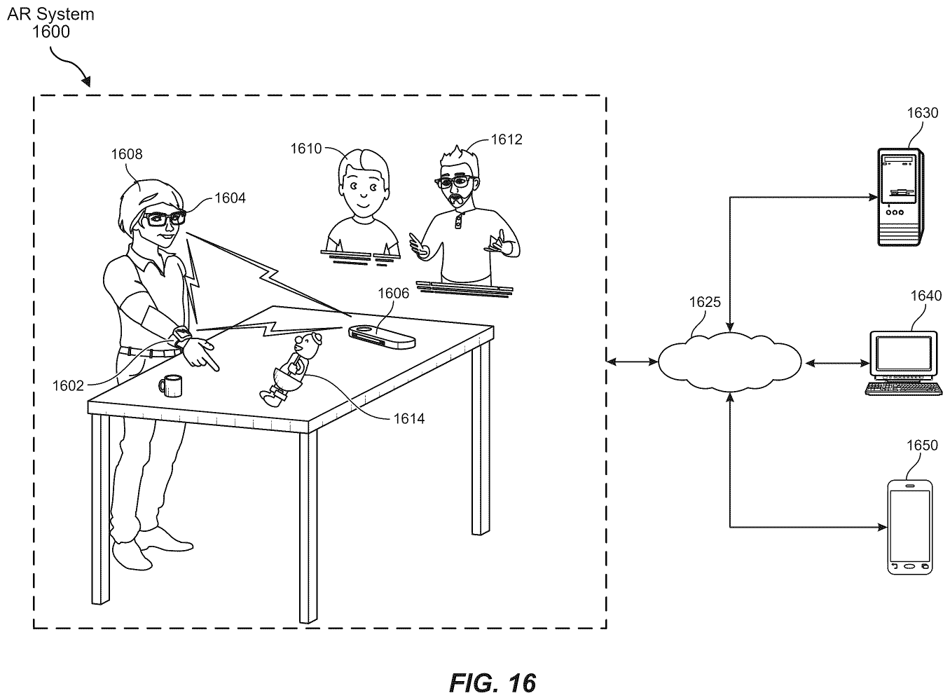

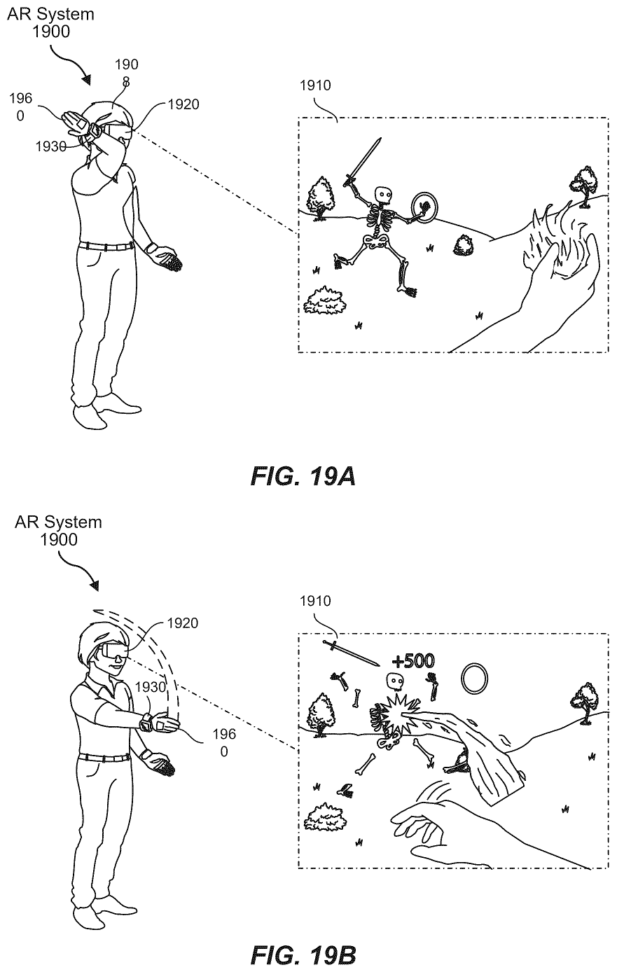

FIGS. 16-19B illustrate example artificial-reality (AR) systems in accordance with some embodiments. FIG. 16 shows a first AR system 1600 and first example user interactions using a wrist-wearable device 1602, a head-wearable device (e.g., AR glasses 2200), and/or a handheld intermediary processing device (HIPD) 1606. FIG. 17 shows a second AR system 1700 and second example user interactions using a wrist-wearable device 1702, AR glasses 1704, and/or an HIPD 1706. FIGS. 18A and 18B show a third AR system 1800 and third example user 1808 interactions using a wrist-wearable device 1802, a head-wearable device (e.g., VR headset 1850), and/or an HIPD 1806. FIGS. 19A and 19B show a fourth AR system 1900 and fourth example user 1908 interactions using a wrist-wearable device 1930, VR headset 1920, and/or a haptic device 1960 (e.g., wearable gloves).

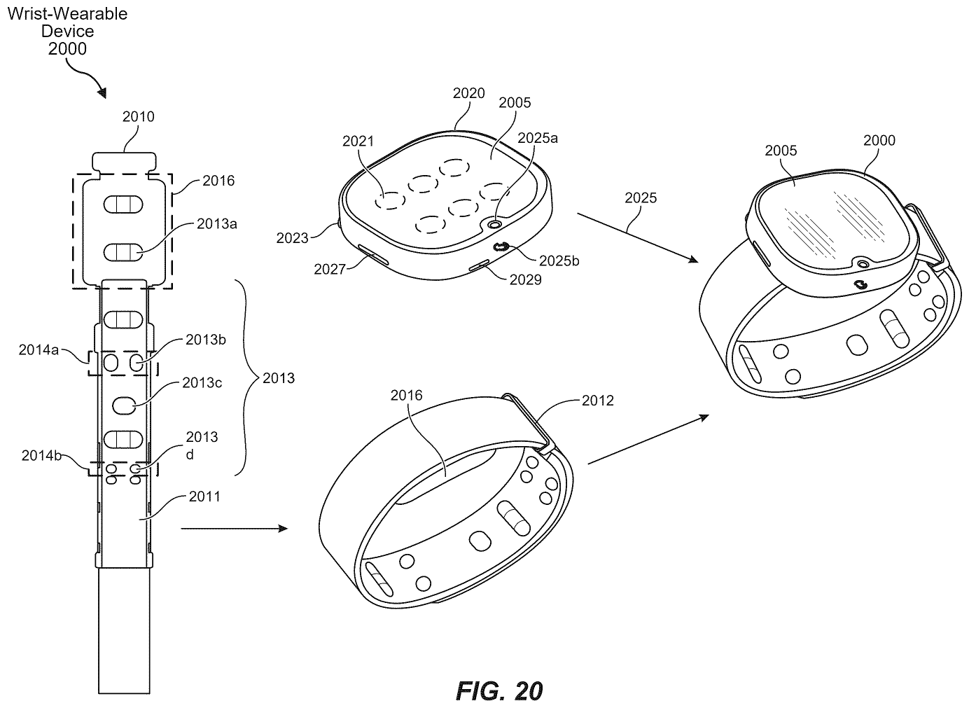

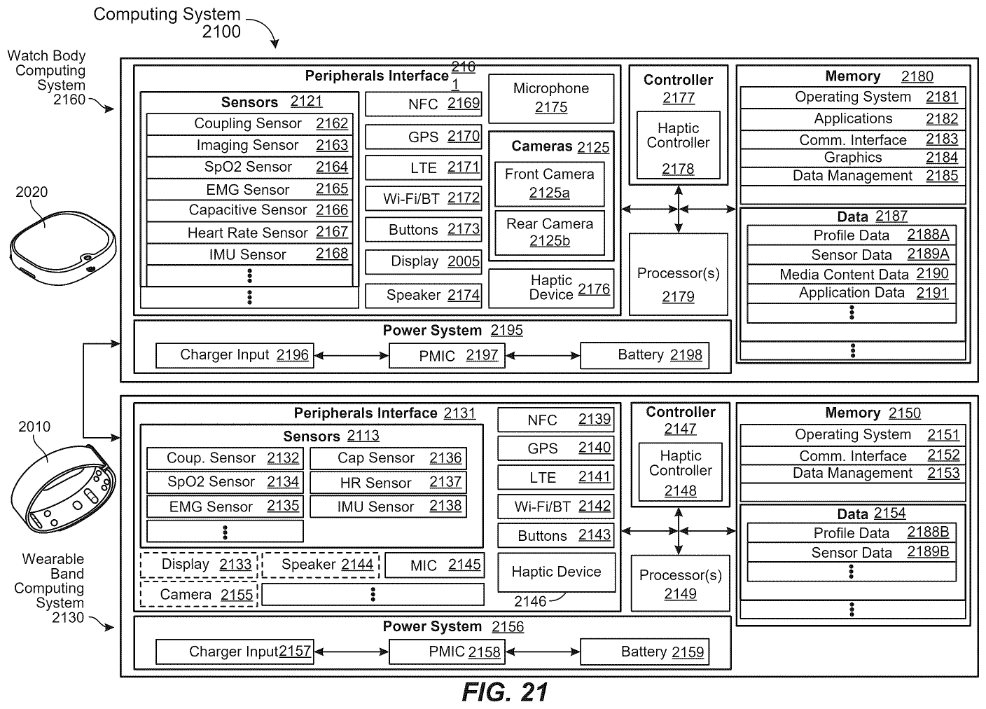

A wrist-wearable device 2000, which can be used for wrist-wearable device 1602, 1702, 1802, 1930, and one or more of its components, are described below in reference to FIGS. 20 and 21; head-wearable devices 2200 and 2300, which can respectively be used for AR glasses 1604, 1704 or VR headset 1850, 1920, and their one or more components are described below in reference to FIGS. 22-24.

Referring to FIG. 16, wrist-wearable device 1602, AR glasses 1604, and/or HIPD 1606 can communicatively couple via a network 1625 (e.g., cellular, near field, Wi-Fi, personal area network, wireless LAN, etc.). Additionally, wrist-wearable device 1602, AR glasses 1604, and/or HIPD 1606 can also communicatively couple with one or more servers 1630, computers 1640 (e.g., laptops, computers, etc.), mobile devices 1650 (e.g., smartphones, tablets, etc.), and/or other electronic devices via network 1625 (e.g., cellular, near field, Wi-Fi, personal area network, wireless LAN, etc.).

In FIG. 16, a user 1608 is shown wearing wrist-wearable device 1602 and AR glasses 1604 and having HIPD 1606 on their desk. The wrist-wearable device 1602, AR glasses 1604, and HIPD 1606 facilitate user interaction with an AR environment. In particular, as shown by first AR system 1600, wrist-wearable device 1602, AR glasses 1604, and/or HIPD 1606 cause presentation of one or more avatars 1610, digital representations of contacts 1612, and virtual objects 1614. As discussed below, user 1608 can interact with one or more avatars 1610, digital representations of contacts 1612, and virtual objects 1614 via wrist-wearable device 1602, AR glasses 1604, and/or HIPD 1606.

User 1608 can use any of wrist-wearable device 1602, AR glasses 1604, and/or HIPD 1606 to provide user inputs. For example, user 1608 can perform one or more hand gestures that are detected by wrist-wearable device 1602 (e.g., using one or more EMG sensors and/or IMUs, described below in reference to FIGS. 20 and 21) and/or AR glasses 1604 (e.g., using one or more image sensor or camera, described below in reference to FIGS. 22-10) to provide a user input. Alternatively, or additionally, user 1608 can provide a user input via one or more touch surfaces of wrist-wearable device 1602, AR glasses 1604, HIPD 1606, and/or voice commands captured by a microphone of wrist-wearable device 1602, AR glasses 1604, and/or HIPD 1606. In some embodiments, wrist-wearable device 1602, AR glasses 1604, and/or HIPD 1606 include a digital assistant to help user 1608 in providing a user input (e.g., completing a sequence of operations, suggesting different operations or commands, providing reminders, confirming a command, etc.). In some embodiments, user 1608 can provide a user input via one or more facial gestures and/or facial expressions. For example, cameras of wrist-wearable device 1602, AR glasses 1604, and/or HIPD 1606 can track eyes of user 1608 for navigating a user interface.

Wrist-wearable device 1602, AR glasses 1604, and/or HIPD 1606 can operate alone or in conjunction to allow user 1608 to interact with the AR environment. In some embodiments, HIPD 1606 is configured to operate as a central hub or control center for the wrist-wearable device 1602, AR glasses 1604, and/or another communicatively coupled device. For example, user 1608 can provide an input to interact with the AR environment at any of wrist-wearable device 1602, AR glasses 1604, and/or HIPD 1606, and HIPD 1606 can identify one or more back-end and front-end tasks to cause the performance of the requested interaction and distribute instructions to cause the performance of the one or more back-end and front-end tasks at wrist-wearable device 1602, AR glasses 1604, and/or HIPD 1606. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). HIPD 1606 can perform the back-end tasks and provide wrist-wearable device 1602 and/or AR glasses 1604 operational data corresponding to the performed back-end tasks such that wrist-wearable device 1602 and/or AR glasses 1604 can perform the front-end tasks. In this way, HIPD 1606, which has more computational resources and greater thermal headroom than wrist-wearable device 1602 and/or AR glasses 1604, performs computationally intensive tasks and reduces the computer resource utilization and/or power usage of wrist-wearable device 1602 and/or AR glasses 1604.

In the example shown by first AR system 1600, HIPD 1606 identifies one or more back-end tasks and front-end tasks associated with a user request to initiate an AR video call with one or more other users (represented by avatar 1610 and the digital representation of contact 1612) and distributes instructions to cause the performance of the one or more back-end tasks and front-end tasks. In particular, HIPD 1606 performs back-end tasks for processing and/or rendering image data (and other data) associated with the AR video call and provides operational data associated with the performed back-end tasks to AR glasses 1604 such that the AR glasses 1604 perform front-end tasks for presenting the AR video call (e.g., presenting avatar 1610 and digital representation of contact 1612).

In some embodiments, HIPD 1606 can operate as a focal or anchor point for causing the presentation of information. This allows user 1608 to be generally aware of where information is presented. For example, as shown in first AR system 1600, avatar 1610 and the digital representation of contact 1612 are presented above HIPD 1606. In particular, HIPD 1606 and AR glasses 1604 operate in conjunction to determine a location for presenting avatar 1610 and the digital representation of contact 1612. In some embodiments, information can be presented a predetermined distance from HIPD 1606 (e.g., within 5 meters). For example, as shown in first AR system 1600, virtual object 1614 is presented on the desk some distance from HIPD 1606. Similar to the above example, HIPD 1606 and AR glasses 1604 can operate in conjunction to determine a location for presenting virtual object 1614. Alternatively, in some embodiments, presentation of information is not bound by HIPD 1606. More specifically, avatar 1610, digital representation of contact 1612, and virtual object 1614 do not have to be presented within a predetermined distance of HIPD 1606.

User inputs provided at wrist-wearable device 1602, AR glasses 1604, and/or HIPD 1606 are coordinated such that the user can use any device to initiate, continue, and/or complete an operation. For example, user 1608 can provide a user input to AR glasses 1604 to cause AR glasses 1604 to present virtual object 1614 and, while virtual object 1614 is presented by AR glasses 1604, user 1608 can provide one or more hand gestures via wrist-wearable device 1602 to interact and/or manipulate virtual object 1614.

FIG. 17 shows a user 1708 wearing a wrist-wearable device 1702 and AR glasses 1704, and holding an HIPD 1706. In second AR system 1700, the wrist-wearable device 1702, AR glasses 1704, and/or HIPD 1706 are used to receive and/or provide one or more messages to a contact of user 1708. In particular, wrist-wearable device 1702, AR glasses 1704, and/or HIPD 1706 detect and coordinate one or more user inputs to initiate a messaging application and prepare a response to a received message via the messaging application.

In some embodiments, user 1708 initiates, via a user input, an application on wrist-wearable device 1702, AR glasses 1704, and/or HIPD 1706 that causes the application to initiate on at least one device. For example, in second AR system 1700, user 1708 performs a hand gesture associated with a command for initiating a messaging application (represented by messaging user interface 1716), wrist-wearable device 1702 detects the hand gesture and, based on a determination that user 1708 is wearing AR glasses 1704, causes AR glasses 1704 to present a messaging user interface 1716 of the messaging application. AR glasses 1704 can present messaging user interface 1716 to user 1708 via its display (e.g., as shown by a field of view 1718 of user 1708). In some embodiments, the application is initiated and executed on the device (e.g., wrist-wearable device 1702, AR glasses 1704, and/or HIPD 1706) that detects the user input to initiate the application, and the device provides another device operational data to cause the presentation of the messaging application. For example, wrist-wearable device 1702 can detect the user input to initiate a messaging application, initiate and run the messaging application, and provide operational data to AR glasses 1704 and/or HIPD 1706 to cause presentation of the messaging application. Alternatively, the application can be initiated and executed at a device other than the device that detected the user input. For example, wrist-wearable device 1702 can detect the hand gesture associated with initiating the messaging application and cause HIPD 1706 to run the messaging application and coordinate the presentation of the messaging application.

Further, user 1708 can provide a user input provided at wrist-wearable device 1702, AR glasses 1704, and/or HIPD 1706 to continue and/or complete an operation initiated at another device. For example, after initiating the messaging application via wrist-wearable device 1702 and while AR glasses 1704 present messaging user interface 1716, user 1708 can provide an input at HIPD 1706 to prepare a response (e.g., shown by the swipe gesture performed on HIPD 1706). Gestures performed by user 1708 on HIPD 1706 can be provided and/or displayed on another device. For example, a swipe gestured performed on HIPD 1706 is displayed on a virtual keyboard of messaging user interface 1716 displayed by AR glasses 1704.

In some embodiments, wrist-wearable device 1702, AR glasses 1704, HIPD 1706, and/or any other communicatively coupled device can present one or more notifications to user 1708. The notification can be an indication of a new message, an incoming call, an application update, a status update, etc. User 1708 can select the notification via wrist-wearable device 1702, AR glasses 1704, and/or HIPD 1706 and can cause presentation of an application or operation associated with the notification on at least one device. For example, user 1708 can receive a notification that a message was received at wrist-wearable device 1702, AR glasses 1704, HIPD 1706, and/or any other communicatively coupled device and can then provide a user input at wrist-wearable device 1702, AR glasses 1704, and/or HIPD 1706 to review the notification, and the device detecting the user input can cause an application associated with the notification to be initiated and/or presented at wrist-wearable device 1702, AR glasses 1704, and/or HIPD 1706.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 1704 can present to user 1708 game application data, and HIPD 1706 can be used as a controller to provide inputs to the game. Similarly, user 1708 can use wrist-wearable device 1702 to initiate a camera of AR glasses 1704, and user 1708 can use wrist-wearable device 1702, AR glasses 1704, and/or HIPD 1706 to manipulate the image capture (e.g., zoom in or out, apply filters, etc.) and capture image data.

Users may interact with the devices disclosed herein in a variety of ways. For example, as shown in FIGS. 18A and 18B, a user 1808 may interact with an AR system 1800 by donning a VR headset 1850 while holding HIPD 1806 and wearing wrist-wearable device 1802. In this example, AR system 1800 may enable a user to interact with a game 1810 by swiping their arm. One or more of VR headset 1850, HIPD 1806, and wrist-wearable device 1802 may detect this gesture and, in response, may display a sword strike in game 1810. Similarly, in FIGS. 19A and 19B, a user 1908 may interact with an AR system 1900 by donning a VR headset 1920 while wearing haptic device 1960 and wrist-wearable device 1930. In this example, AR system 1900 may enable a user to interact with a game 1910 by swiping their arm. One or more of VR headset 1920, haptic device 1960, and wrist-wearable device 1930 may detect this gesture and, in response, may display a spell being cast in game 1810.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and

Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiogra sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configure to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 2202.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 20 and 21 illustrate an example wrist-wearable device 2000 and an example computer system 2100, in accordance with some embodiments. Wrist-wearable device 2000 is an instance of wearable device 1602 described in FIG. 16 herein, such that the wearable device 1602 should be understood to have the features of the wrist-wearable device 2000 and vice versa. FIG. 21 illustrates components of the wrist-wearable device 2000, which can be used individually or in combination, including combinations that include other electronic devices and/or electronic components.

FIG. 20 shows a wearable band 2010 and a watch body 2020 (or capsule) being coupled, as discussed below, to form wrist-wearable device 2000. Wrist-wearable device 2000 can perform various functions and/or operations associated with navigating through user interfaces and selectively opening applications as well as the functions and/or operations described above with reference to FIGS. 16-19B.

As will be described in more detail below, operations executed by wrist-wearable device 2000 can include (i) presenting content to a user (e.g., displaying visual content via a display 2005), (ii) detecting (e.g., sensing) user input (e.g., sensing a touch on peripheral button 2023 and/or at a touch screen of the display 2005, a hand gesture detected by sensors (e.g., biopotential sensors)), (iii) sensing biometric data (e.g., neuromuscular signals, heart rate, temperature, sleep, etc.) via one or more sensors 2013, messaging (e.g., text, speech, video, etc.); image capture via one or more imaging devices or cameras 2025, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 2020, independently in wearable band 2010, and/or via an electronic communication between watch body 2020 and wearable band 2010. In some embodiments, functions can be executed on wrist-wearable device 2000 while an AR environment is being presented (e.g., via one of AR systems 1600 to 1900). The wearable devices described herein can also be used with other types of AR environments.

Wearable band 2010 can be configured to be worn by a user such that an inner surface of a wearable structure 2011 of wearable band 2010 is in contact with the user's skin. In this example, when worn by a user, sensors 2013 may contact the user's skin. In some examples, one or more of sensors 2013 can sense biometric data such as a user's heart rate, a saturated oxygen level, temperature, sweat level, neuromuscular signals, or a combination thereof. One or more of sensors 2013 can also sense data about a user's environment including a user's motion, altitude, location, orientation, gait, acceleration, position, or a combination thereof. In some embodiment, one or more of sensors 2013 can be configured to track a position and/or motion of wearable band 2010. One or more of sensors 2013 can include any of the sensors defined above and/or discussed below with respect to FIG. 20.

One or more of sensors 2013 can be distributed on an inside and/or an outside surface of wearable band 2010. In some embodiments, one or more of sensors 2013 are uniformly spaced along wearable band 2010. Alternatively, in some embodiments, one or more of sensors 2013 are positioned at distinct points along wearable band 2010. As shown in FIG. 20, one or more of sensors 2013 can be the same or distinct. For example, in some embodiments, one or more of sensors 2013 can be shaped as a pill (e.g., sensor 2013a), an oval, a circle a square, an oblong (e.g., sensor 2013c) and/or any other shape that maintains contact with the user's skin (e.g., such that neuromuscular signal and/or other biometric data can be accurately measured at the user's skin). In some embodiments, one or more sensors of 2013 are aligned to form pairs of sensors (e.g., for sensing neuromuscular signals based on differential sensing within each respective sensor). For example, sensor 2013b may be aligned with an adjacent sensor to form sensor pair 2014a and sensor 2013d may be aligned with an adjacent sensor to form sensor pair 2014b. In some embodiments, wearable band 2010 does not have a sensor pair. Alternatively, in some embodiments, wearable band 2010 has a predetermined number of sensor pairs (one pair of sensors, three pairs of sensors, four pairs of sensors, six pairs of sensors, sixteen pairs of sensors, etc.).

Wearable band 2010 can include any suitable number of sensors 2013. In some embodiments, the number and arrangement of sensors 2013 depends on the particular application for which wearable band 2010 is used. For instance, wearable band 2010 can be configured as an armband, wristband, or chest-band that include a plurality of sensors 2013 with different number of sensors 2013, a variety of types of individual sensors with the plurality of sensors 2013, and different arrangements for each use case, such as medical use cases as compared to gaming or general day-to-day use cases.

In accordance with some embodiments, wearable band 2010 further includes an electrical ground electrode and a shielding electrode. The electrical ground and shielding electrodes, like the sensors 2013, can be distributed on the inside surface of the wearable band 2010 such that they contact a portion of the user's skin. For example, the electrical ground and shielding electrodes can be at an inside surface of a coupling mechanism 2016 or an inside surface of a wearable structure 2011. The electrical ground and shielding electrodes can be formed and/or use the same components as sensors 2013. In some embodiments, wearable band 2010 includes more than one electrical ground electrode and more than one shielding electrode.

Sensors 2013 can be formed as part of wearable structure 2011 of wearable band 2010. In some embodiments, sensors 2013 are flush or substantially flush with wearable structure 2011 such that they do not extend beyond the surface of wearable structure 2011. While flush with wearable structure 2011, sensors 2013 are still configured to contact the user's skin (e.g., via a skin-contacting surface). Alternatively, in some embodiments, sensors 2013 extend beyond wearable structure 2011 a predetermined distance (e.g., 0.1-2 mm) to make contact and depress into the user's skin. In some embodiment, sensors 2013 are coupled to an actuator (not shown) configured to adjust an extension height (e.g., a distance from the surface of wearable structure 2011) of sensors 2013 such that sensors 2013 make contact and depress into the user's skin. In some embodiments, the actuators adjust the extension height between 0.01 mm-1.2 mm. This may allow a the user to customize the positioning of sensors 2013 to improve the overall comfort of the wearable band 2010 when worn while still allowing sensors 2013 to contact the user's skin. In some embodiments, sensors 2013 are indistinguishable from wearable structure 2011 when worn by the user.

Wearable structure 2011 can be formed of an elastic material, elastomers, etc., configured to be stretched and fitted to be worn by the user. In some embodiments, wearable structure 2011 is a textile or woven fabric. As described above, sensors 2013 can be formed as part of a wearable structure 2011. For example, sensors 2013 can be molded into the wearable structure 2011, be integrated into a woven fabric (e.g., sensors 2013 can be sewn into the fabric and mimic the pliability of fabric and can and/or be constructed from a series woven strands of fabric).

Wearable structure 2011 can include flexible electronic connectors that interconnect sensors 2013, the electronic circuitry, and/or other electronic components (described below in reference to FIG. 21) that are enclosed in wearable band 2010. In some embodiments, the flexible electronic connectors are configured to interconnect sensors 2013, the electronic circuitry, and/or other electronic components of wearable band 2010 with respective sensors and/or other electronic components of another electronic device (e.g., watch body 2020). The flexible electronic connectors are configured to move with wearable structure 2011 such that the user adjustment to wearable structure 2011 (e.g., resizing, pulling, folding, etc.) does not stress or strain the electrical coupling of components of wearable band 2010.

As described above, wearable band 2010 is configured to be worn by a user.

In particular, wearable band 2010 can be shaped or otherwise manipulated to be worn by a user. For example, wearable band 2010 can be shaped to have a substantially circular shape such that it can be configured to be worn on the user's lower arm or wrist. Alternatively, wearable band 2010 can be shaped to be worn on another body part of the user, such as the user's upper arm (e.g., around a bicep), forearm, chest, legs, etc. Wearable band 2010 can include a retaining mechanism 2012 (e.g., a buckle, a hook and loop fastener, etc.) for securing wearable band 2010 to the user's wrist or other body part. While wearable band 2010 is worn by the user, sensors 2013 sense data (referred to as sensor data) from the user's skin. In some examples, sensors 2013 of wearable band 2010 obtain (e.g., sense and record) neuromuscular signals.

The sensed data (e.g., sensed neuromuscular signals) can be used to detect and/or determine the user's intention to perform certain motor actions. In some examples, sensors 2013 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 2005 of wrist-wearable device 2000 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 2013 can be used to provide a user with an enhanced interaction with a physical object (e.g., devices communicatively coupled with wearable band 2010) and/or a virtual object in an artificial-reality application generated by an artificial-reality system (e.g., user interface objects presented on the display 2005, or another computing device (e.g., a smartphone)).

In some embodiments, wearable band 2010 includes one or more haptic devices 2146 (e.g., a vibratory haptic actuator) that are configured to provide haptic feedback (e.g., a cutaneous and/or kinesthetic sensation, etc.) to the user's skin. Sensors 2013 and/or haptic devices 2146 (shown in FIG. 21) can be configured to operate in conjunction with multiple applications including, without limitation, health monitoring, social media, games, and artificial reality (e.g., the applications associated with artificial reality).

Wearable band 2010 can also include coupling mechanism 2016 for detachably coupling a capsule (e.g., a computing unit) or watch body 2020 (via a coupling surface of the watch body 2020) to wearable band 2010. For example, a cradle or a shape of coupling mechanism 2016 can correspond to shape of watch body 2020 of wrist-wearable device 2000. In particular, coupling mechanism 2016 can be configured to receive a coupling surface proximate to the bottom side of watch body 2020 (e.g., a side opposite to a front side of watch body 2020 where display 2005 is located), such that a user can push watch body 2020 downward into coupling mechanism 2016 to attach watch body 2020 to coupling mechanism 2016. In some embodiments, coupling mechanism 2016 can be configured to receive a top side of the watch body 2020 (e.g., a side proximate to the front side of watch body 2020 where display 2005 is located) that is pushed upward into the cradle, as opposed to being pushed downward into coupling mechanism 2016. In some embodiments, coupling mechanism 2016 is an integrated component of wearable band 2010 such that wearable band 2010 and coupling mechanism 2016 are a single unitary structure. In some embodiments, coupling mechanism 2016 is a type of frame or shell that allows watch body 2020 coupling surface to be retained within or on wearable band 2010 coupling mechanism 2016 (e.g., a cradle, a tracker band, a support base, a clasp, etc.).

Coupling mechanism 2016 can allow for watch body 2020 to be detachably coupled to the wearable band 2010 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 2020 to wearable band 2010 and to decouple the watch body 2020 from the wearable band 2010. For example, a user can twist, slide, turn, push, pull, or rotate watch body 2020 relative to wearable band 2010, or a combination thereof, to attach watch body 2020 to wearable band 2010 and to detach watch body 2020 from wearable band 2010. Alternatively, as discussed below, in some embodiments, the watch body 2020 can be decoupled from the wearable band 2010 by actuation of a release mechanism 2029.

Wearable band 2010 can be coupled with watch body 2020 to increase the functionality of wearable band 2010 (e.g., converting wearable band 2010 into wrist-wearable device 2000, adding an additional computing unit and/or battery to increase computational resources and/or a battery life of wearable band 2010, adding additional sensors to improve sensed data, etc.). As described above, wearable band 2010 and coupling mechanism 2016 are configured to operate independently (e.g., execute functions independently) from watch body 2020. For example, coupling mechanism 2016 can include one or more sensors 2013 that contact a user's skin when wearable band 2010 is worn by the user, with or without watch body 2020 and can provide sensor data for determining control commands.

A user can detach watch body 2020 from wearable band 2010 to reduce the encumbrance of wrist-wearable device 2000 to the user. For embodiments in which watch body 2020 is removable, watch body 2020 can be referred to as a removable structure, such that in these embodiments wrist-wearable device 2000 includes a wearable portion (e.g., wearable band 2010) and a removable structure (e.g., watch body 2020).

Turning to watch body 2020, in some examples watch body 2020 can have a substantially rectangular or circular shape. Watch body 2020 is configured to be worn by the user on their wrist or on another body part. More specifically, watch body 2020 is sized to be easily carried by the user, attached on a portion of the user's clothing, and/or coupled to wearable band 2010 (forming the wrist-wearable device 2000). As described above, watch body 2020 can have a shape corresponding to coupling mechanism 2016 of wearable band 2010. In some embodiments, watch body 2020 includes a single release mechanism 2029 or multiple release mechanisms (e.g., two release mechanisms 2029 positioned on opposing sides of watch body 2020, such as spring-loaded buttons) for decoupling watch body 2020 from wearable band 2010. Release mechanism 2029 can include, without limitation, a button, a knob, a plunger, a handle, a lever, a fastener, a clasp, a dial, a latch, or a combination thereof.

A user can actuate release mechanism 2029 by pushing, turning, lifting, depressing, shifting, or performing other actions on release mechanism 2029. Actuation of release mechanism 2029 can release (e.g., decouple) watch body 2020 from coupling mechanism 2016 of wearable band 2010, allowing the user to use watch body 2020 independently from wearable band 2010 and vice versa. For example, decoupling watch body 2020 from wearable band 2010 can allow a user to capture images using rear-facing camera 2025b. Although release mechanism 2029 is shown positioned at a corner of watch body 2020, release mechanism 2029 can be positioned anywhere on watch body 2020 that is convenient for the user to actuate. In addition, in some embodiments, wearable band 2010 can also include a respective release mechanism for decoupling watch body 2020 from coupling mechanism 2016. In some embodiments, release mechanism 2029 is optional and watch body 2020 can be decoupled from coupling mechanism 2016 as described above (e.g., via twisting, rotating, etc.).

Watch body 2020 can include one or more peripheral buttons 2023 and 2027 for performing various operations at watch body 2020. For example, peripheral buttons 2023 and 2027 can be used to turn on or wake (e.g., transition from a sleep state to an active state) display 2005, unlock watch body 2020, increase or decrease a volume, increase or decrease a brightness, interact with one or more applications, interact with one or more user interfaces, etc.

Additionally or alternatively, in some embodiments, display 2005 operates as a touch screen and allows the user to provide one or more inputs for interacting with watch body 2020.

In some embodiments, watch body 2020 includes one or more sensors 2021. Sensors 2021 of watch body 2020 can be the same or distinct from sensors 2013 of wearable band 2010. Sensors 2021 of watch body 2020 can be distributed on an inside and/or an outside surface of watch body 2020. In some embodiments, sensors 2021 are configured to contact a user's skin when watch body 2020 is worn by the user. For example, sensors 2021 can be placed on the bottom side of watch body 2020 and coupling mechanism 2016 can be a cradle with an opening that allows the bottom side of watch body 2020 to directly contact the user's skin.

Alternatively, in some embodiments, watch body 2020 does not include sensors that are configured to contact the user's skin (e.g., including sensors internal and/or external to the watch body 2020 that are configured to sense data of watch body 2020 and the surrounding environment). In some embodiments, sensors 2021 are configured to track a position and/or motion of watch body 2020.

Watch body 2020 and wearable band 2010 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 2020 and wearable band 2010 can share data sensed by sensors 2013 and 2021, as well as application and device specific information (e.g., active and/or available applications, output devices (e.g., displays, speakers, etc.), input devices (e.g., touch screens, microphones, imaging sensors, etc.).

In some embodiments, watch body 2020 can include, without limitation, a front-facing camera 2025a and/or a rear-facing camera 2025b, sensors 2021 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 2163), a touch sensor, a sweat sensor, etc.). In some embodiments, watch body 2020 can include one or more haptic devices 2176 (e.g., a vibratory haptic actuator) that is configured to provide haptic feedback (e.g., a cutaneous and/or kinesthetic sensation, etc.) to the user. Sensors 2121 and/or haptic device 2176 can also be configured to operate in conjunction with multiple applications including, without limitation, health monitoring applications, social media applications, game applications, and artificial reality applications (e.g., the applications associated with artificial reality).

As described above, watch body 2020 and wearable band 2010, when coupled, can form wrist-wearable device 2000. When coupled, watch body 2020 and wearable band 2010 may operate as a single device to execute functions (operations, detections, communications, etc.) described herein. In some embodiments, each device may be provided with particular instructions for performing the one or more operations of wrist-wearable device 2000. For example, in accordance with a determination that watch body 2020 does not include neuromuscular signal sensors, wearable band 2010 can include alternative instructions for performing associated instructions (e.g., providing sensed neuromuscular signal data to watch body 2020 via a different electronic device). Operations of wrist-wearable device 2000 can be performed by watch body 2020 alone or in conjunction with wearable band 2010 (e.g., via respective processors and/or hardware components) and vice versa. In some embodiments, operations of wrist-wearable device 2000, watch body 2020, and/or wearable band 2010 can be performed in conjunction with one or more processors and/or hardware components.

As described below with reference to the block diagram of FIG. 21, wearable band 2010 and/or watch body 2020 can each include independent resources required to independently execute functions. For example, wearable band 2010 and/or watch body 2020 can each include a power source (e.g., a battery), a memory, data storage, a processor (e.g., a central processing unit (CPU)), communications, a light source, and/or input/output devices.

FIG. 21 shows block diagrams of a computing system 2130 corresponding to wearable band 2010 and a computing system 2160 corresponding to watch body 2020 according to some embodiments. Computing system 2100 of wrist-wearable device 2000 may include a combination of components of wearable band computing system 2130 and watch body computing system 2160, in accordance with some embodiments.

Watch body 2020 and/or wearable band 2010 can include one or more components shown in watch body computing system 2160. In some embodiments, a single integrated circuit may include all or a substantial portion of the components of watch body computing system 2160 included in a single integrated circuit. Alternatively, in some embodiments, components of the watch body computing system 2160 may be included in a plurality of integrated circuits that are communicatively coupled. In some embodiments, watch body computing system 2160 may be configured to couple (e.g., via a wired or wireless connection) with wearable band computing system 2130, which may allow the computing systems to share components, distribute tasks, and/or perform other operations described herein (individually or as a single device).

Watch body computing system 2160 can include one or more processors 2179, a controller 2177, a peripherals interface 2161, a power system 2195, and memory (e.g., a memory 2180).

Power system 2195 can include a charger input 2196, a power-management integrated circuit (PMIC) 2197, and a battery 2198. In some embodiments, a watch body 2020 and a wearable band 2010 can have respective batteries (e.g., battery 2198 and 2159) and can share power with each other. Watch body 2020 and wearable band 2010 can receive a charge using a variety of techniques. In some embodiments, watch body 2020 and wearable band 2010 can use a wired charging assembly (e.g., power cords) to receive the charge. Alternatively, or in addition, watch body 2020 and/or wearable band 2010 can be configured for wireless charging. For example, a portable charging device can be designed to mate with a portion of watch body 2020 and/or wearable band 2010 and wirelessly deliver usable power to battery 2198 of watch body 2020 and/or battery 2159 of wearable band 2010. Watch body 2020 and wearable band 2010 can have independent power systems (e.g., power system 2195 and 2156, respectively) to enable each to operate independently. Watch body 2020 and wearable band 2010 can also share power (e.g., one can charge the other) via respective PMICs (e.g., PMICs 2197 and 2158) and charger inputs (e.g., 2157 and 2196) that can share power over power and ground conductors and/or over wireless charging antennas.

In some embodiments, peripherals interface 2161 can include one or more sensors 2121. Sensors 2121 can include one or more coupling sensors 2162 for detecting when watch body 2020 is coupled with another electronic device (e.g., a wearable band 2010). Sensors 2121 can include one or more imaging sensors 2163 (e.g., one or more of cameras 2125, and/or separate imaging sensors 2163 (e.g., thermal-imaging sensors)). In some embodiments, sensors 2121 can include one or more SpO2 sensors 2164. In some embodiments, sensors 2121 can include one or more biopotential-signal sensors (e.g., EMG sensors 2165, which may be disposed on an interior, user-facing portion of watch body 2020 and/or wearable band 2010). In some embodiments, sensors 2121 may include one or more capacitive sensors 2166. In some embodiments, sensors 2121 may include one or more heart rate sensors 2167. In some embodiments, sensors 2121 may include one or more IMU sensors 2168. In some embodiments, one or more IMU sensors 2168 can be configured to detect movement of a user's hand or other location where watch body 2020 is placed or held.

In some embodiments, one or more of sensors 2121 may provide an example human-machine interface. For example, a set of neuromuscular sensors, such as EMG sensors 2165, may be arranged circumferentially around wearable band 2010 with an interior surface of EMG sensors 2165 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 2010 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 2179. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 2165 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 2161 includes a near-field communication (NFC) component 2169, a global-position system (GPS) component 2170, a long-term evolution (LTE) component 2171, and/or a Wi-Fi and/or Bluetooth communication component 2172. In some embodiments, peripherals interface 2161 includes one or more buttons 2173 (e.g., peripheral buttons 2023 and 2027 in FIG. 20), which, when selected by a user, cause operation to be performed at watch body 2020. In some embodiments, the peripherals interface 2161 includes one or more indicators, such as a light emitting diode (LED), to provide a user with visual indicators (e.g., message received, low battery, active microphone and/or camera, etc.).

Watch body 2020 can include at least one display 2005 for displaying visual representations of information or data to a user, including user-interface elements and/or three-dimensional virtual objects. The display can also include a touch screen for inputting user inputs, such as touch gestures, swipe gestures, and the like. Watch body 2020 can include at least one speaker 2174 and at least one microphone 2175 for providing audio signals to the user and receiving audio input from the user. The user can provide user inputs through microphone 2175 and can also receive audio output from speaker 2174 as part of a haptic event provided by haptic controller 2178. Watch body 2020 can include at least one camera 2125, including a front camera 2125a and a rear camera 2125b. Cameras 2125 can include ultra-wide-angle cameras, wide angle cameras, fish-eye cameras, spherical cameras, telephoto cameras, depth-sensing cameras, or other types of cameras.

Watch body computing system 2160 can include one or more haptic controllers 2178 and associated componentry (e.g., haptic devices 2176) for providing haptic events at watch body 2020 (e.g., a vibrating sensation or audio output in response to an event at the watch body 2020). Haptic controllers 2178 can communicate with one or more haptic devices 2176, such as electroacoustic devices, including a speaker of the one or more speakers 2174 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 2178 can provide haptic events to that are capable of being sensed by a user of watch body 2020. In some embodiments, one or more haptic controllers 2178 can receive input signals from an application of applications 2182.

In some embodiments, wearable band computing system 2130 and/or watch body computing system 2160 can include memory 2180, which can be controlled by one or more memory controllers of controllers 2177. In some embodiments, software components stored in memory 2180 include one or more applications 2182 configured to perform operations at the watch body 2020. In some embodiments, one or more applications 2182 may include games, word processors, messaging applications, calling applications, web browsers, social media applications, media streaming applications, financial applications, calendars, clocks, etc. In some embodiments, software components stored in memory 2180 include one or more communication interface modules 2183 as defined above. In some embodiments, software components stored in memory 2180 include one or more graphics modules 2184 for rendering, encoding, and/or decoding audio and/or visual data and one or more data management modules 2185 for collecting, organizing, and/or providing access to data 2187 stored in memory 2180. In some embodiments, one or more of applications 2182 and/or one or more modules can work in conjunction with one another to perform various tasks at the watch body 2020.

In some embodiments, software components stored in memory 2180 can include one or more operating systems 2181 (e.g., a Linux-based operating system, an Android operating system, etc.). Memory 2180 can also include data 2187. Data 2187 can include profile data 2188A, sensor data 2189A, media content data 2190, and application data 2191.

It should be appreciated that watch body computing system 2160 is an example of a computing system within watch body 2020, and that watch body 2020 can have more or fewer components than shown in watch body computing system 2160, can combine two or more components, and/or can have a different configuration and/or arrangement of the components. The various components shown in watch body computing system 2160 are implemented in hardware, software, firmware, or a combination thereof, including one or more signal processing and/or application-specific integrated circuits.

Turning to the wearable band computing system 2130, one or more components that can be included in wearable band 2010 are shown. Wearable band computing system 2130 can include more or fewer components than shown in watch body computing system 2160, can combine two or more components, and/or can have a different configuration and/or arrangement of some or all of the components. In some embodiments, all, or a substantial portion of the components of wearable band computing system 2130 are included in a single integrated circuit. Alternatively, in some embodiments, components of wearable band computing system 2130 are included in a plurality of integrated circuits that are communicatively coupled. As described above, in some embodiments, wearable band computing system 2130 is configured to couple (e.g., via a wired or wireless connection) with watch body computing system 2160, which allows the computing systems to share components, distribute tasks, and/or perform other operations described herein (individually or as a single device).

Wearable band computing system 2130, similar to watch body computing system 2160, can include one or more processors 2149, one or more controllers 2147 (including one or more haptics controllers 2148), a peripherals interface 2131 that can includes one or more sensors 2113 and other peripheral devices, a power source (e.g., a power system 2156), and memory (e.g., a memory 2150) that includes an operating system (e.g., an operating system 2151), data (e.g., data 2154 including profile data 2188B, sensor data 2189B, etc.), and one or more modules (e.g., a communications interface module 2152, a data management module 2153, etc.).

One or more of sensors 2113 can be analogous to sensors 2121 of watch body computing system 2160. For example, sensors 2113 can include one or more coupling sensors 2132, one or more SpO2 sensors 2134, one or more EMG sensors 2135, one or more capacitive sensors 2136, one or more heart rate sensors 2137, and one or more IMU sensors 2138.

Peripherals interface 2131 can also include other components analogous to those included in peripherals interface 2161 of watch body computing system 2160, including an NFC component 2139, a GPS component 2140, an LTE component 2141, a Wi-Fi and/or Bluetooth communication component 2142, and/or one or more haptic devices 2146 as described above in reference to peripherals interface 2161. In some embodiments, peripherals interface 2131 includes one or more buttons 2143, a display 2133, a speaker 2144, a microphone 2145, and a camera 2155. In some embodiments, peripherals interface 2131 includes one or more indicators, such as an LED.

It should be appreciated that wearable band computing system 2130 is an example of a computing system within wearable band 2010, and that wearable band 2010 can have more or fewer components than shown in wearable band computing system 2130, combine two or more components, and/or have a different configuration and/or arrangement of the components. The various components shown in wearable band computing system 2130 can be implemented in one or more of a combination of hardware, software, or firmware, including one or more signal processing and/or application-specific integrated circuits.

Wrist-wearable device 2000 with respect to FIG. 20 is an example of wearable band 2010 and watch body 2020 coupled together, so wrist-wearable device 2000 will be understood to include the components shown and described for wearable band computing system 2130 and watch body computing system 2160. In some embodiments, wrist-wearable device 2000 has a split architecture (e.g., a split mechanical architecture, a split electrical architecture, etc.) between watch body 2020 and wearable band 2010. In other words, all of the components shown in wearable band computing system 2130 and watch body computing system 2160 can be housed or otherwise disposed in a combined wrist-wearable device 2000 or within individual components of watch body 2020, wearable band 2010, and/or portions thereof (e.g., a coupling mechanism 2016 of wearable band 2010).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 2000 can be used in conjunction with a head-wearable device (e.g., AR glasses 2200 and VR system 2310) and/or an HIPD, and wrist-wearable device 2000 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR glasses 2200 and VR headset 2310.

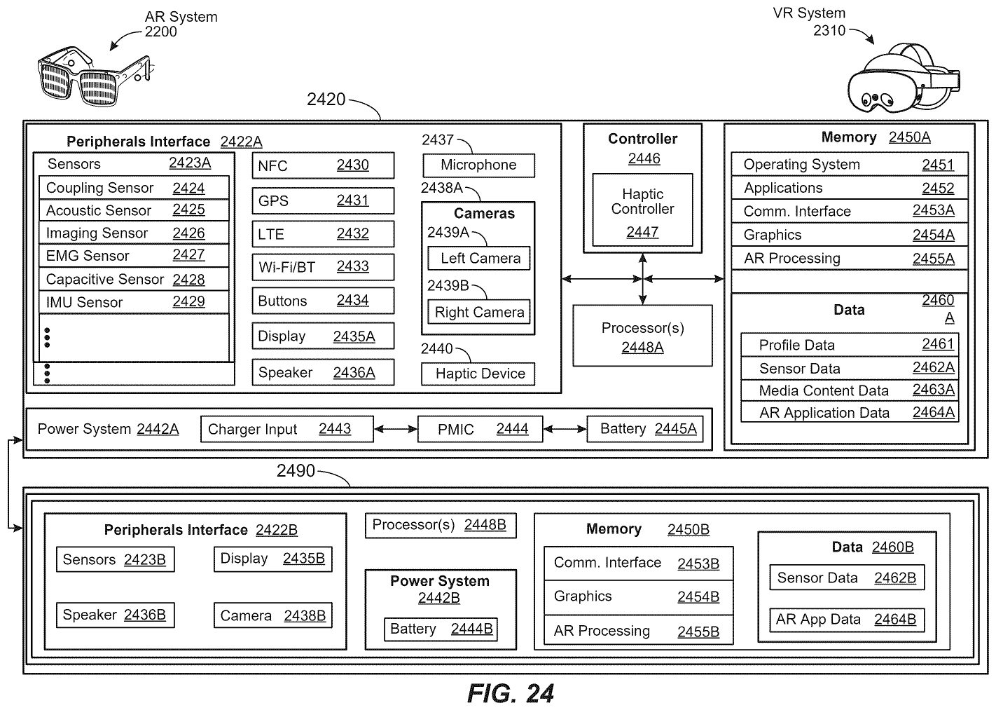

FIGS. 22 to 24 show example artificial-reality systems, which can be used as or in connection with wrist-wearable device 2000. In some embodiments, AR system 2200 includes an eyewear device 2202, as shown in FIG. 22. In some embodiments, VR system 2310 includes a head-mounted display (HMD) 2312, as shown in FIGS. 23A and 23B. In some embodiments, AR system 2200 and VR system 2310 can include one or more analogous components (e.g., components for presenting interactive artificial-reality environments, such as processors, memory, and/or presentation devices, including one or more displays and/or one or more waveguides), some of which are described in more detail with respect to FIG. 24. As described herein, a head-wearable device can include components of eyewear device 2202 and/or head-mounted display 2312. Some embodiments of head-wearable devices do not include any displays, including any of the displays described with respect to AR system 2200 and/or VR system 2310. While the example artificial-reality systems are respectively described herein as AR system 2200 and VR system 2310, either or both of the example AR systems described herein can be configured to present fully-immersive virtual-reality scenes presented in substantially all of a user's field of view or subtler augmented-reality scenes that are presented within a portion, less than all, of the user's field of view.

FIG. 22 show an example visual depiction of AR system 2200, including an eyewear device 2202 (which may also be described herein as augmented-reality glasses, and/or smart glasses). AR system 2200 can include additional electronic components that are not shown in FIG. 22, such as a wearable accessory device and/or an intermediary processing device, in electronic communication or otherwise configured to be used in conjunction with the eyewear device 2202. In some embodiments, the wearable accessory device and/or the intermediary processing device may be configured to couple with eyewear device 2202 via a coupling mechanism in electronic communication with a coupling sensor 2424 (FIG. 24), where coupling sensor 2424 can detect when an electronic device becomes physically or electronically coupled with eyewear device 2202. In some embodiments, eyewear device 2202 can be configured to couple to a housing 2490 (FIG. 24), which may include one or more additional coupling mechanisms configured to couple with additional accessory devices. The components shown in FIG. 22 can be implemented in hardware, software, firmware, or a combination thereof, including one or more signal-processing components and/or application-specific integrated circuits (ASICs).

Eyewear device 2202 includes mechanical glasses components, including a frame 2204 configured to hold one or more lenses (e.g., one or both lenses 2206-1 and 2206-2). One of ordinary skill in the art will appreciate that eyewear device 2202 can include additional mechanical components, such as hinges configured to allow portions of frame 2204 of eyewear device 2202 to be folded and unfolded, a bridge configured to span the gap between lenses 2206-1 and 2206-2 and rest on the user's nose, nose pads configured to rest on the bridge of the nose and provide support for eyewear device 2202, earpieces configured to rest on the user's ears and provide additional support for eyewear device 2202, temple arms configured to extend from the hinges to the earpieces of eyewear device 2202, and the like. One of ordinary skill in the art will further appreciate that some examples of AR system 2200 can include none of the mechanical components described herein. For example, smart contact lenses configured to present artificial reality to users may not include any components of eyewear device 2202.

Eyewear device 2202 includes electronic components, many of which will be described in more detail below with respect to FIG. 24. Some example electronic components are illustrated in FIG. 22, including acoustic sensors 2225-1, 2225-2, 2225-3, 2225-4, 2225-5, and 2225-6, which can be distributed along a substantial portion of the frame 2204 of eyewear device 2202. Eyewear device 2202 also includes a left camera 2239A and a right camera 2239B, which are located on different sides of the frame 2204. Eyewear device 2202 also includes a processor 2248 (or any other suitable type or form of integrated circuit) that is embedded into a portion of the frame 2204.

FIGS. 23A and 23B show a VR system 2310 that includes a head-mounted display (HMD) 2312 (e.g., also referred to herein as an artificial-reality headset, a head-wearable device, a VR headset, etc.), in accordance with some embodiments. As noted, some artificial-reality systems (e.g., AR system 2200) may, instead of blending an artificial reality with actual reality, substantially replace one or more of a user's visual and/or other sensory perceptions of the real world with a virtual experience (e.g., AR systems 1800 and 1900).

HMD 2312 includes a front body 2314 and a frame 2316 (e.g., a strap or band) shaped to fit around a user's head. In some embodiments, front body 2314 and/or frame 2316 include one or more electronic elements for facilitating presentation of and/or interactions with an AR and/or VR system (e.g., displays, IMUs, tracking emitter or detectors). In some embodiments, HMD 2312 includes output audio transducers (e.g., an audio transducer 2318), as shown in FIG. 23B. In some embodiments, one or more components, such as the output audio transducer(s) 2318 and frame 2316, can be configured to attach and detach (e.g., are detachably attachable) to HMD 2312 (e.g., a portion or all of frame 2316, and/or audio transducer 2318), as shown in FIG. 23B. In some embodiments, coupling a detachable component to HMD 2312 causes the detachable component to come into electronic communication with HMD 2312.

FIGS. 23A and 23B also show that VR system 2310 includes one or more cameras, such as left camera 2339A and right camera 2339B, which can be analogous to left and right cameras 2239A and 2239B on frame 2204 of eyewear device 2202. In some embodiments, VR system 2310 includes one or more additional cameras (e.g., cameras 2339C and 2339D), which can be configured to augment image data obtained by left and right cameras 2339A and 2339B by providing more information. For example, camera 2339C can be used to supply color information that is not discerned by cameras 2339A and 2339B. In some embodiments, one or more of cameras 2339A to 2339D can include an optional IR cut filter configured to remove IR light from being received at the respective camera sensors.

FIG. 24 illustrates a computing system 2420 and an optional housing 2490, each of which show components that can be included in AR system 2200 and/or VR system 2310. In some embodiments, more or fewer components can be included in optional housing 2490 depending on practical restraints of the respective AR system being described.

In some embodiments, computing system 2420 can include one or more peripherals interfaces 2422A and/or optional housing 2490 can include one or more peripherals interfaces 2422B. Each of computing system 2420 and optional housing 2490 can also include one or more power systems 2442A and 2442B, one or more controllers 2446 (including one or more haptic controllers 2447), one or more processors 2448A and 2448B (as defined above, including any of the examples provided), and memory 2450A and 2450B, which can all be in electronic communication with each other. For example, the one or more processors 2448A and 2448B can be configured to execute instructions stored in memory 2450A and 2450B, which can cause a controller of one or more of controllers 2446 to cause operations to be performed at one or more peripheral devices connected to peripherals interface 2422A and/or 2422B. In some embodiments, each operation described can be powered by electrical power provided by power system 2442A and/or 2442B.

In some embodiments, peripherals interface 2422A can include one or more devices configured to be part of computing system 2420, some of which have been defined above and/or described with respect to the wrist-wearable devices shown in FIGS. 20 and 21. For example, peripherals interface 2422A can include one or more sensors 2423A. Some example sensors 2423A include one or more coupling sensors 2424, one or more acoustic sensors 2425, one or more imaging sensors 2426, one or more EMG sensors 2427, one or more capacitive sensors 2428, one or more IMU sensors 2429, and/or any other types of sensors explained above or described with respect to any other embodiments discussed herein.

In some embodiments, peripherals interfaces 2422A and 2422B can include one or more additional peripheral devices, including one or more NFC devices 2430, one or more GPS devices 2431, one or more LTE devices 2432, one or more Wi-Fi and/or Bluetooth devices 2433, one or more buttons 2434 (e.g., including buttons that are slidable or otherwise adjustable), one or more displays 2435A and 2435B, one or more speakers 2436A and 2436B, one or more microphones 2437, one or more cameras 2438A and 2438B (e.g., including the left camera 2439A and/or a right camera 2439B), one or more haptic devices 2440, and/or any other types of peripheral devices defined above or described with respect to any other embodiments discussed herein.

AR systems can include a variety of types of visual feedback mechanisms (e.g., presentation devices). For example, display devices in AR system 2200 and/or VR system 2310 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 2435A and 2435B can be coupled to each of the lenses 2206-1 and 2206-2 of AR system 2200. Displays 2435A and 2435B may be coupled to each of lenses 2206-1 and 2206-2, which can act together or independently to present an image or series of images to a user. In some embodiments, AR system 2200 includes a single display 2435A or 2435B (e.g., a near-eye display) or more than two displays 2435A and 2435B. In some embodiments, a first set of one or more displays 2435A and 2435B can be used to present an augmented-reality environment, and a second set of one or more display devices 2435A and 2435B can be used to present a virtual-reality environment. In some embodiments, one or more waveguides are used in conjunction with presenting artificial-reality content to the user of AR system 2200 (e.g., as a means of delivering light from one or more displays 2435A and 2435B to the user's eyes). In some embodiments, one or more waveguides are fully or partially integrated into the eyewear device 2202. Additionally, or alternatively to display screens, some artificial-reality systems include one or more projection systems. For example, display devices in AR system 2200 and/or VR system 2310 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 2435A and 2435B.

Computing system 2420 and/or optional housing 2490 of AR system 2200 or VR system 2310 can include some or all of the components of a power system 2442A and 2442B. Power systems 2442A and 2442B can include one or more charger inputs 2443, one or more PMICs 2444, and/or one or more batteries 2445A and 2444B.

Memory 2450A and 2450B may include instructions and data, some or all of which may be stored as non-transitory computer-readable storage media within the memories 2450A and 2450B. For example, memory 2450A and 2450B can include one or more operating systems 2451, one or more applications 2452, one or more communication interface applications 2453A and 2453B, one or more graphics applications 2454A and 2454B, one or more AR processing applications 2455A and 2455B, and/or any other types of data defined above or described with respect to any other embodiments discussed herein.

Memory 2450A and 2450B also include data 2460A and 2460B, which can be used in conjunction with one or more of the applications discussed above. Data 2460A and 2460B can include profile data 2461, sensor data 2462A and 2462B, media content data 2463A, AR application data 2464A and 2464B, and/or any other types of data defined above or described with respect to any other embodiments discussed herein.

In some embodiments, controller 2446 of eyewear device 2202 may process information generated by sensors 2423A and/or 2423B on eyewear device 2202 and/or another electronic device within AR system 2200. For example, controller 2446 can process information from acoustic sensors 2225-1 and 2225-2. For each detected sound, controller 2446 can perform a direction of arrival (DOA) estimation to estimate a direction from which the detected sound arrived at eyewear device 2202 of AR system 2200. As one or more of acoustic sensors 2425 (e.g., the acoustic sensors 2225-1, 2225-2) detects sounds, controller 2446 can populate an audio data set with the information (e.g., represented in FIG. 24 as sensor data 2462A and 2462B).

In some embodiments, a physical electronic connector can convey information between eyewear device 2202 and another electronic device and/or between one or more processors 2248, 2448A, 2448B of AR system 2200 or VR system 2310 and controller 2446. The information can be in the form of optical data, electrical data, wireless data, or any other transmittable data form. Moving the processing of information generated by eyewear device 2202 to an intermediary processing device can reduce weight and heat in the eyewear device, making it more comfortable and safer for a user. In some embodiments, an optional wearable accessory device (e.g., an electronic neckband) is coupled to eyewear device 2202 via one or more connectors. The connectors can be wired or wireless connectors and can include electrical and/or non-electrical (e.g., structural) components. In some embodiments, eyewear device 2202 and the wearable accessory device can operate independently without any wired or wireless connection between them.

In some situations, pairing external devices, such as an intermediary processing device (e.g., HIPD 1606, 1706, 1806) with eyewear device 2202 (e.g., as part of AR system 2200) enables eyewear device 2202 to achieve a similar form factor of a pair of glasses while still providing sufficient battery and computation power for expanded capabilities. Some, or all, of the battery power, computational resources, and/or additional features of AR system 2200 can be provided by a paired device or shared between a paired device and eyewear device 2202, thus reducing the weight, heat profile, and form factor of eyewear device 2202 overall while allowing eyewear device 2202 to retain its desired functionality. For example, the wearable accessory device can allow components that would otherwise be included on eyewear device 2202 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 2202 standing alone. Because weight carried in the wearable accessory device can be less invasive to a user than weight carried in the eyewear device 2202, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 2200 and/or VR system 2310 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 23A and 23B show VR system 2310 having cameras 2339A to 2339D, which can be used to provide depth information for creating a voxel field and a two-dimensional mesh to provide object information to the user to avoid collisions.

In some embodiments, AR system 2200 and/or VR system 2310 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 2200 and/or VR system 2310, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

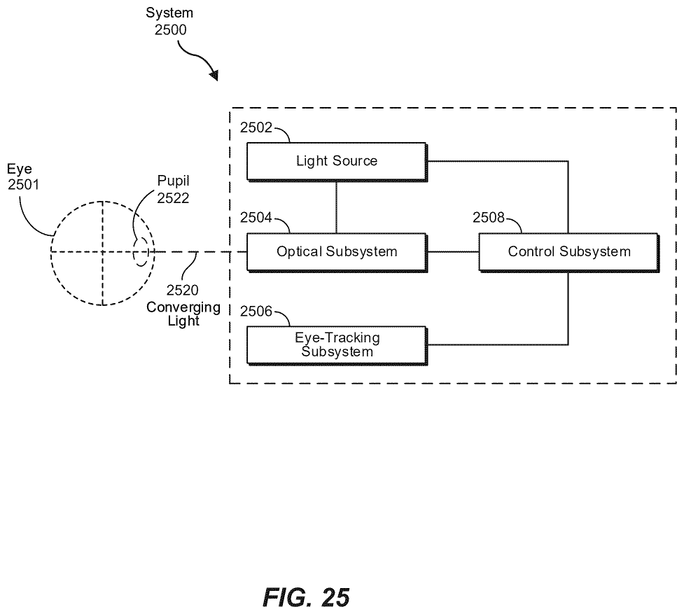

FIG. 25 is an illustration of an example system 2500 that incorporates an eye-tracking subsystem capable of tracking a user's eye(s). As depicted in FIG. 25, system 2500 may include a light source 2502, an optical subsystem 2504, an eye-tracking subsystem 2506, and/or a control subsystem 2508. In some examples, light source 2502 may generate light for an image (e.g., to be presented to an eye 2501 of the viewer). Light source 2502 may represent any of a variety of suitable devices. For example, light source 2502 can include a two-dimensional projector (e.g., a LCOS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 2504 may receive the light generated by light source 2502 and generate, based on the received light, converging light 2520 that includes the image. In some examples, optical subsystem 2504 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 2520. Further, various mechanical couplings may serve to maintain the relative spacing and/or the orientation of the optical components in any suitable combination.

In one embodiment, eye-tracking subsystem 2506 may generate tracking information indicating a gaze angle of an eye 2501 of the viewer. In this embodiment, control subsystem 2508 may control aspects of optical subsystem 2504 (e.g., the angle of incidence of converging light 2520) based at least in part on this tracking information. Additionally, in some examples, control subsystem 2508 may store and utilize historical tracking information (e.g., a history of the tracking information over a given duration, such as the previous second or fraction thereof) to anticipate the gaze angle of eye 2501 (e.g., an angle between the visual axis and the anatomical axis of eye 2501). In some embodiments, eye-tracking subsystem 2506 may detect radiation emanating from some portion of eye 2501 (e.g., the cornea, the iris, the pupil, or the like) to determine the current gaze angle of eye 2501. In other examples, eye-tracking subsystem 2506 may employ a wavefront sensor to track the current location of the pupil.

Any number of techniques can be used to track eye 2501. Some techniques may involve illuminating eye 2501 with infrared light and measuring reflections with at least one optical sensor that is tuned to be sensitive to the infrared light. Information about how the infrared light is reflected from eye 2501 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 2506 may be digitized (i.e., converted to an electronic signal). Further, the sensor may transmit a digital representation of this electronic signal to one or more processors (for example, processors associated with a device including eye-tracking subsystem 2506). Eye-tracking subsystem 2506 may include any of a variety of sensors in a variety of different configurations. For example, eye-tracking subsystem 2506 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 2506 to track the movement of eye 2501. In another example, these processors may track the movements of eye 2501 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 2506 may be programmed to use an output of the sensor(s) to track movement of eye 2501. In some embodiments, eye-tracking subsystem 2506 may analyze the digital representation generated by the sensors to extract eye rotation information from changes in reflections. In one embodiment, eye-tracking subsystem 2506 may use corneal reflections or glints (also known as Purkinje images) and/or the center of the eye's pupil 2522 as features to track over time.

In some embodiments, eye-tracking subsystem 2506 may use the center of the eye's pupil 2522 and infrared or near-infrared, non-collimated light to create corneal reflections. In these embodiments, eye-tracking subsystem 2506 may use the vector between the center of the eye's pupil 2522 and the corneal reflections to compute the gaze direction of eye 2501. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 2506 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 2501 may act as a retroreflector as the light reflects off the retina, thereby creating a bright pupil effect similar to a red-eye effect in photography. If the illumination source is offset from the optical path, then the eye's pupil 2522 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 2508 may control light source 2502 and/or optical subsystem 2504 to reduce optical aberrations (e.g., chromatic aberrations and/or monochromatic aberrations) of the image that may be caused by or influenced by eye 2501. In some examples, as mentioned above, control subsystem 2508 may use the tracking information from eye-tracking subsystem 2506 to perform such control. For example, in controlling light source 2502, control subsystem 2508 may alter the light generated by light source 2502 (e.g., by way of image rendering) to modify (e.g., pre-distort) the image so that the aberration of the image caused by eye 2501 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

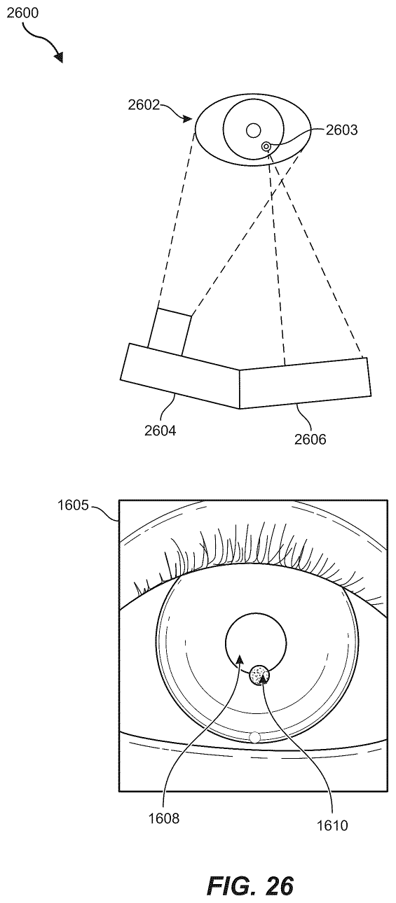

FIG. 26 is a more detailed illustration of various aspects of the eye-tracking subsystem illustrated in FIG. 25. As shown in this figure, an eye-tracking subsystem 2600 may include at least one source 2604 and at least one sensor 2606. Source 2604 generally represents any type or form of element capable of emitting radiation. In one example, source 2604 may generate visible, infrared, and/or near-infrared radiation. In some examples, source 2604 may radiate non-collimated infrared and/or near-infrared portions of the electromagnetic spectrum towards an eye 2602 of a user. Source 2604 may utilize a variety of sampling rates and speeds.

For example, the disclosed systems may use sources with higher sampling rates in order to capture fixational eye movements of a user's eye 2602 and/or to correctly measure saccade dynamics of the user's eye 2602. As noted above, any type or form of eye-tracking technique may be used to track the user's eye 2602, including optical-based eye-tracking techniques, ultrasound-based eye-tracking techniques, etc.

Sensor 2606 generally represents any type or form of element capable of detecting radiation, such as radiation reflected off the user's eye 2602. Examples of sensor 2606 include, without limitation, a charge coupled device (CCD), a photodiode array, a complementary metal-oxide-semiconductor (CMOS) based sensor device, and/or the like. In one example, sensor 2606 may represent a sensor having predetermined parameters, including, but not limited to, a dynamic resolution range, linearity, and/or other characteristic selected and/or designed specifically for eye tracking.

As detailed above, eye-tracking subsystem 2600 may generate one or more glints. As detailed above, a glint 2603 may represent reflections of radiation (e.g., infrared radiation from an infrared source, such as source 2604) from the structure of the user's eye. In various embodiments, glint 2603 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 26 shows an example image 2605 captured by an eye-tracking subsystem, such as eye-tracking subsystem 2600. In this example, image 2605 may include both the user's pupil 2608 and a glint 2610 near the same. In some examples, pupil 2608 and/or glint 2610 may be identified using an artificial-intelligence-based algorithm, such as a computer-vision-based algorithm. In one embodiment, image 2605 may represent a single frame in a series of frames that may be analyzed continuously in order to track the eye 2602 of the user. Further, pupil 2608 and/or glint 2610 may be tracked over a period of time to determine a user's gaze.

In one example, eye-tracking subsystem 2600 may be configured to identify and measure the inter-pupillary distance (IPD) of a user. In some embodiments, eye-tracking subsystem 2600 may measure and/or calculate the IPD of the user while the user is wearing the artificial reality system. In these embodiments, eye-tracking subsystem 2600 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more of the various components of system 2500 and/or eye-tracking subsystem 2600 may be incorporated into any of the augmented-reality systems in and/or virtual-reality systems described herein in to enable these systems to perform various eye-tracking tasks (including one or more of the eye-tracking operations described herein).

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a plurality of addressable display elements arranged into a plurality of rows and a plurality of columns;
a plurality of clock signal lines;
a plurality of gate driver units, each gate driver unit coupled to one or more clock signal lines of the plurality of clock signal lines and configured to send a gate signal to one or more of the plurality of rows of display elements based on clock signals provided along the one or more clock signal lines; and
a controller configured to generate the clock signals, thereby causing the plurality of gate driver units to send gate signals to respective rows of the plurality of rows of display elements, wherein the clock signals are controlled, according to a foveated display pattern, to adjust a number of gate signals that are simultaneously sent to the respective rows.

2. The system of claim 1, wherein the controller is configured to:
generate the clock signals during a first display period, thereby causing a first gate driver unit of the plurality of gate driver units to send the gate signal to one or more of the plurality of rows of display elements during the first display period; and
send a respective display signal to each of the plurality of columns of display elements during the first display period.

3. The system of claim 2, wherein the controller is configured to, when the foveated display pattern includes a macropixel:
generate the clock signals during the first display period, thereby causing the first gate driver unit of the plurality of gate driver units to simultaneously send the gate signal to at least two of the plurality of rows of display elements during the first display period; and
simultaneously send respective display signals to at least two of the plurality of columns of display elements during the first display period.

4. The system of claim 3, wherein the respective display signals simultaneously sent to the at least two of the plurality of columns of display elements during the first display period are the same display signal.

5. The system of claim 4, wherein:
the first gate driver unit of the plurality of gate driver units simultaneously sends the gate signal to four of the plurality of rows of display elements during the first display period; and
the controller is further configured to simultaneously send the same display signal to four of the plurality of columns of display elements during the first display period.

6. The system of claim 1, wherein the plurality of gate driver units includes a first gate driver having a plurality of clock inputs coupled to a first subset of the plurality of clock signal lines, and a second gate driver having the plurality of clock inputs coupled to a second subset of the plurality of clock signal lines, the second subset being different from the first subset.

7. The system of claim 6, wherein at least one of the plurality of clock inputs of a respective gate driver of the plurality of gate driver units enables or disables the respective gate driver with respect to sending one or more gate signals.

8. The system of claim 1, wherein the controller, the plurality of gate driver units and the plurality of clock signal lines are implemented as an integrated circuit.

9. A method comprising:
sending, by a first gate driver unit receiving first clock signals from a first subset of a plurality of clock signal lines, a gate signal simultaneously to each of a first number of rows of a plurality of display elements;
sending, by a second gate driver unit receiving second clock signals from a second subset of the plurality of clock signal lines, different from the first subset, a gate signal simultaneously to each of a second number of rows of the plurality of display elements, wherein the second number of rows is different from the first number of rows.

10. The method of claim 9, further comprising adjusting a phase of the first clock signals to produce the second clock signals.

11. The method of claim 9, further comprising generating the first clock signals and the second clock signals by a controller according to image data.

12. The method of claim 9, wherein the plurality of display elements are arranged in a plurality of columns and a plurality of rows, and wherein the method further comprises simultaneously directing the gate signal to each of the first number of rows of the plurality of display elements and directing a display signal to one or more of the plurality of columns of display elements, thereby simultaneously directing both the display signal and the gate signal to one or more display elements.

13. A system comprising:
a plurality of addressable display elements arranged into a plurality of rows and a plurality of columns; and
a controller comprising a plurality of demultiplexers and configured to, according to image data received by the controller:
simultaneously relay, by a first demultiplexer of the plurality of demultiplexers, first display data to a first number of the plurality of columns of display elements; and
subsequent to relaying the first display data to the first number of the plurality of columns of display elements, simultaneously relay, by a second demultiplexer of the plurality of demultiplexers, second display data to a second number of the plurality of columns of display elements, different from the first number of the plurality of columns of display elements.

14. The system of claim 13, wherein the image data comprises a plurality of demultiplexing indicators, and wherein the controller is configured to select one of the plurality of demultiplexers to receive display data based on one of the plurality of demultiplexing indicators.

15. The system of claim 14, wherein the controller is configured to, based on the image data comprising a first demultiplexing indicator, first image data, a second demultiplexing indicator and second image data, send the first display data to the first demultiplexer based on the first demultiplexing indicator and the first image data, and send the second display data to the second demultiplexer based on the second demultiplexing indicator and the second image data.

16. The system of claim 15, wherein the first number of the plurality of columns of display elements is greater than 1, and wherein the second number of the plurality of columns of display elements is 1.

17. The system of claim 13, wherein the plurality of columns of display elements are configured with alternating polarity, and wherein the first demultiplexer comprises:
a first input configured to route a first portion of the first display data to a first column of the plurality of columns of display elements; and
a second input configured to route a second portion of the first display data to a second column of the plurality of columns of display elements, the second column being adjacent to and having opposite polarity to the first column.

18. The system of claim 17, wherein the controller is configured to generate the first portion of the first display data as a polarity inverted version of the second portion of the first display data.

19. A method comprising:
simultaneously relaying, by a first demultiplexer of a plurality of demultiplexers, first display data to a first number of a plurality of columns of display elements of a display; and
subsequent to relaying the first display data to the first number of the plurality of columns of display elements, simultaneously relaying, by a second demultiplexer of the plurality of demultiplexers, second display data to a second number of the plurality of columns of display elements, different from the first number of the plurality of columns of display elements.

20. The method of claim 19, further comprising, by a controller according to image data comprising a plurality of demultiplexing indicators, selecting one of a plurality of demultiplexers that includes the first demultiplexer and the second demultiplexer to receive display data based on one of the plurality of demultiplexing indicators.

21. The method of claim 19, herein the first number of the plurality of columns of display elements is greater than 1, and wherein the second number of the plurality of columns of display elements is 1.

22. The method of claim 19, wherein relaying the first display data to the first number of the plurality of columns of display elements comprises relaying the first display data to multiple of the plurality of columns of display elements configured to produce the same color of light.
